(19) United States
(12) Patent Application Publication
(10) Pub. No.: US 2006/0109403 A1
(43) Pub. Date: May 25, 2006

(54) Optical film, polarizing plate, liquid crystal cell, liquid crystal display device, image display device and method of manufacturing an optical film

(75) Inventors: Nao Murakami, Osaka (JP); Hiroyuki Yoshimi, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi (JP)

(21) Appl. No.: 11/281,554

(22) Filed: Nov. 18, 2005

(30) Foreign Application Priority Data
Nov. 22, 2004 (JP) 2004-336926
Jul. 13, 2005 (JP) 2005-204219

(51) Int. Cl. G02F 1/1335

(52) U.S. Cl. 349/119

(57) ABSTRACT

An optical film includes a transparent polymer film layer, an adhesive layer formed by coating a polyurethane-based resin solution on the transparent polymer film layer, a birefringent layer formed by coating a non-liquid crystal polymer on the adhesive layer. These layers together form a laminated film that is subjected to a stretching treatment. The thus formed optical film is unlikely to cause separation of the transparent polymer film from the birefringent layer and to cause variation in retardation of the birefringent layer.

### CROSS REFERENCE TO RELATED APPLICATION

This application claims priority from Japanese Patent Application Nos. 2004-336926 and 2005-204219, which are incorporated herein by reference.

### BACKGROUND OF THE INVENTION

1. Field of the Invention

The present invention relates to an optical film that includes a transparent polymer film layer and a birefringent layer made of a non-liquid crystal polymer, etc.

2. Discussion of the Background

An optical film of the above type hitherto known includes a transparent polymer film layer, and a birefringent layer made of a non-liquid crystal polymer that is directly laminated on the transparent polymer film layer by coating, as disclosed such as in Japanese Patent Application Publication No. 2004-46065.

The optical film having the above structure is generally subjected to stretching and shrinking treatments or cutting according to needs and circumstances, and used as an optical film, for example, in a liquid crystal display (LCD) device. This optical film may have a transparent polymer film layer partially separated and hence displaced from a birefringent layer under stress during stretching, shrinking or cutting treatments, as well as being hard to have a flat and smooth surface due to microscopic irregular surface configuration or surface undulation of a transparent polymer film, with the result that the optical film may cause variation in retardation of the birefringent layer, or uneven display when it is used in an image display device of an LCD device, or cause any problems on optical characteristics.

It is an object of the present invention to provide an optical film that is unlikely to cause separation of the transparent polymer film from the birefringent layer and to cause variation in retardation of the birefringent layer. It is another object of the present invention to provide an optical film or the like that is unlikely to cause uneven display when it is used in an image display device.

### SUMMARY OF THE INVENTION

As a result of intentional and repeated studies by the present inventors, it was found that the above objects can be achieved by the following means. Hence, the present invention has been achieved.

According to one aspect of the present invention, there is provided an optical film that includes a transparent polymer film layer, an adhesive layer formed by coating a solution containing a polyurethane-based resin on the transparent polymer film layer, and a birefringent layer formed by coating a solution containing a non-liquid crystal polymer on the adhesive layer, these layers together forming a laminated film that is subjected to a stretching treatment.

According to another aspect of the present invention, there is provided a polarizing plate that includes the aforesaid optical film and a polarizer.

According to still another aspect of the present invention, there is provided a liquid crystal cell that includes any one of the aforesaid optical film and the aforesaid polarizing plate.

According to another aspect of the present invention, there is provided a liquid crystal display device that includes the aforesaid liquid crystal cell.

According to yet another aspect of the present invention, there is provided an image display device that includes any one of the aforesaid optical film and the aforesaid polarizing plate.

According to another aspect of the present invention, there is provided a method of manufacturing an optical film that includes forming an adhesive layer by coating a solution containing a polyurethane-based resin on a transparent polymer film layer and forming a birefringent layer by coating a solution containing a non-liquid crystal polymer on the adhesive layer so as to prepare a laminated film, and subjecting the laminated film to a stretching treatment.

Since the polyurethane-based resin of the optical film of the present invention exhibits a good adhesive power with respect to both the transparent polymer film and the birefringent layer of the non-liquid crystal polymer, the transparent polymer film is unlikely to be separated from the birefringent layer, and the thus formed optical film makes it possible to limit variation in retardation of the birefringent layer.

### BRIEF DESCRIPTION OF THE DRAWINGS

The above, and other objects, features and advantages of the present invention will become apparent from the detailed description thereof in conjunction with the accompanying drawings wherein.

FIG. 1 is a photograph of an appearance of Example 22.

FIG. 2 is a photograph of an appearance of Example 43.

FIG. 3 is a photograph of an image of an LCD device in black display mode, using an optical film of Example 22.

FIG. 4 is a photograph of an image of an LCD device in black display mode, using an optical film of Example 50.

### DETAILED DESCRIPTION OF THE PREFERRED EMBODIMENT

An embodiment according to the present invention will be hereinafter described in detail.

An optical film of this embodiment includes a transparent polymer film layer, an adhesive layer containing a urethane-based resin that is formed on the transparent polymer film layer, a birefringent layer containing a non-liquid crystal polymer that is formed on the adhesive layer. These layers together form a laminated film that is subjected to a stretching treatment. Specifically, an adhesive layer is formed by directly coating a polyurethane-based resin solution on a transparent polymer film layer and drying the same, and a birefringent layer is formed by directly coating a non-liquid crystal polymer on the dried adhesive layer so that the transparent polymer film layer, the adhesive layer and the birefringent layer are directly laminated to each other, thus forming a laminated film that is subjected to a stretching treatment while its laminated structure is kept unchanged.

The transparent polymer film layer is made of a transparent polymer film, for which a film being excellent in transparency, mechanical strength, heat stability, moisture shielding characteristics, isotropy, etc. is preferably used. Examples of a main component of the transparent polymer film include polyester-based polymer such as polyethylene terephthalate, and polyethylene naphthalate; cellulose-based polymer such as diacetylcellulose, and triacetylcellulose; acrylic-based polymer such as polymethyl methacrylate; styrene-based polymer such as polystyrene, and acrylonitrile-styrene copolymer (AS resin); and polycarbonate-based polymer. Examples of the main component of the transparent polymer film further include: polyolefin-based polymer such as polyethylene, polypropylene, polyolefin having a cyclo or norbornene structure, and ethylene-propylene copolymer; vinyl chloride-based polymer; amide-based polymer such as Nylon, and aromatic polyamide; imide-based polymer; sulfone-based polymer; polyether-sulfone-based polymer; polyether-ether-ketone-based polymer; polyphenylene sulfide-based polymer; vinyl alcohol-based polymer; vinylidene chloride-based polymer; vinyl butyral-based polymer; allylate-based polymer; polyoxymethylene-based polymer; epoxy-based polymer; and blends of these polymers. Among these films, preferable are a triacetylcellulose film, a film made of a thermoplastic resin having an imide group, a phenyl group or a nitrile group in a side chain (hereinafter referred to an HT film) and a norbornene-based resin film. As the HT film, it is possible to use a film made mainly of a thermoplastic resin having a substituted or non-substituted imide group in a side chain, a film made mainly of a thermoplastic resin having substituted or non-substituted phenyl group and nitrile group in a side chain, or a film made mainly of a thermoplastic resin having a substituted or non-substituted imide group in a side chain and a thermoplastic resin having substituted or non-substituted phenyl group and nitrile group in a side chain.

By the norbornene-based resin film is meant a film in which a resin obtained by addition polymerization of a norbornene-based monomer is used as a main component. Examples of the norbornene-based monomers include norbornene, derivatives substituted by a polar group such as norbornene, its alkyl- and/or alkylidene-substituted derivatives, or a halogen thereof, dicyclopentadiene, 2,3-dihydrodicyclopentadiene or the like; dimethanooctahydronaphthalene and its alkyl- and/or alkylidene-substituted derivatives, or derivatives substituted by a polar group such as a halogen thereof; and trimers and tetramers of cyclopentadiene. Examples of alkyl- and/or alkylidene-substituted derivatives of the norbornene include 5-methyl-2-norbornene, 5-dimethyl-2-norbornene, 5-ethyl-2-norbornene, 5-butyl-2-norbornene, and 5-ethylidene-2-norbornene. Examples of the dimethanooctahydronaphthalene and its alkyl- and/or alkylidene-substituted derivatives, or derivatives substituted by a polar group such as a halogen thereof include 6-methyl-1,4:5,8-dimethano-1,4,4a,5,6, 7,8,8a-octahydronaphthalene, 6-ethyl-1,4:5, 8-dimethano-1,4,4a, 5,6, 7,8,8a-octahydronaphthalene, 6-ethylidene-1,4:5,8-dimethano-1,4,4a,5,6,7,8,8a-octahydronaphthalene, 6-chloro-1,4:5,8-dimethano-1,4,4a,5,6,7,8,8a-octahydronaphthalene, 6-cyano-1,4:5,8-dimethano-1,4,4a,5,6, 7,8,8a-octahydronaphthalene, 6-pyridyl-1,4:5,8-dimethano-1,4,4a, 5,6, 7,8,8a-octahydronaphthalene, and 6-methoxycarbonyl-1,4:5,8-dimethano-1,4,4a, 5,6,7,8,8a-octahydronaphthalene. Examples of the trimers and tetramers of cyclopentadiene include 4,9:5,8-dimethano-3a,4,4a,5,8,8a,9,9a-octahydro-1H-benzoindene, and 4,11:5,10:6,9-trimethano-3a,4,4a,5,5a,6, 9, 9a, 10, 10a, 11, 11a,-dodecahydro-1H-cyclopentaanthracene.

A light stabilizer, an ultraviolet absorber, an antioxidant, a filler or other additives may be mixed to the transparent polymer film according to needs and circumstances. A known surface modification treatment such as a corona treatment may be performed.

The transparent polymer film is not necessarily limited in thickness, but has a thickness of preferably 3-300 μm and more preferably 10-100 μm.

The adhesive layer is formed on the transparent polymer film by directly coating a polyurethane-based resin solution with the resin dissolved or dispersed in a liquid (hereinafter respectively referred to dissolved liquid or dispersed liquid) on the transparent polymer film, and drying the same. The adhesive layer, which is formed by the coating of the polyurethane-based resin solution, can alleviate the influence of the microscopic irregular surface configuration or surface undulation of the transparent polymer film on the retardation value.

Examples of the polyurethane-based resin include polyester-based polyurethane (modified polyester urethane, water-dispersible polyester urethane, solvent-based polyester urethane), polyether-based urethane and polycarbonate-based urethane. These polyurethane-based resins may be of a self-emulsifying type or nonself-emulsifying type. Of these types of polyurethane, preferable is polyester-based polyurethane. These polyurethane-based resins are generally manufactured from polyol and polyisocyanate.

Examples of the polyol include polyester polyol, polyether polyol or other types of polyol.

The polyester polyol is a reaction product of fatty acid and polyol. Examples of the fatty acid include a hydroxy long chain fatty acid of such as ricinolic acid, oxycaproic acid, oxycapric acid, oxyundecanoic acid, oxylinolenic acid, oxystearic acid or oxyhexadecenoic acid. Examples of polyol to be reacted with a fatty acid include: glycol such as ethylene glycol, propylene glycol, butylene glycol, hexamethylene glycol and diethylene glycol; a trifunctional polyol such as glycerin, trimethylolpropane and triethanolamine; a tetrafunctional polyol such as diglycerin and pentaerythritol; hexafunctional polyol such as sugar; an addition polymer of alkylene oxide, which corresponds to these polyols, and aliphatic, alicyclic or aromatic amine; and an addition polymer of the aforesaid alkylene oxide and polyamide polyamine.

Examples of the polyether polyol include an addition copolymer of any one of dihydric alcohol and trihydric or higher polyhydric alcohol, and alkylene oxide, in which examples of the dihydric alcohol include ethylene glycol, diethylene glycol, propylene glycol, dipropylene glycol, 1,3-butandiol, 1,4-butandiol, 4,4′-dihydroxyphenylpropane, 4,4′-dihydroxyphenylmethane; examples of the trihydric or higher polyhydric alcohol include glycerin, and 1,1,1-trimethylolpropane, 1,2,5-hexanetriole, pentaerythritol; and examples of the alkylene oxide include ethylene oxide, propylene oxide, butylene oxide, and α-olefin oxide.

Examples of the other polyols include polyols whose main chain is composed of carbon-carbon bond, for example, acrylic polyol, polybutadiene polyol, polyisoprene polyol, hydrogenated polybutadiene polyol, polyols obtained by graft polymerization of AN (acrylonitrile) or SM (styrene monomer) onto those polyols whose main chain is composed of carbon-carbon bond, polycarbonate polyol, and PTMG (polytetramethylene glycol).

Examples of the polyisocyanate include aromatic polyisocyanate, aliphatic polyisocyanate, and alicyclic polyisocyanate. Examples of the aromatic polyisocyanate include diphenylmethane diisocyanate (MDI), polymethylene polyphenylene isocyanate (polymer MDI), tolylene diisocyanate (TDI), polytrilen polyisocyanate (polymer TDI), xylendiisocyanate (XDI), and naphthalenediisocyanate (NDI). An example of the aliphatic polyisocyanate includes hexamethylenediisocyanate (HDI). An example of the alicyclic polyisocyanate includes isophoronediisocyanate (IPDI). Examples of the aforesaid polyisocyanate further include carbodiimide-modified polyisocyanate (polyisocyanate being the aforesaid polyisocyanate modified with carbodiimide), isocyanurate-modified polyisocyanate, and urethaneprepolymer (e.g., a reaction product between olyol and excess polyisocyanate having an isocyanate group in end terminals thereof). These may be used alone or in mixture.

Examples of solvents of the solution (also referred as the dissolved liquid and the dispersed liquid), include water, a variety of organic solvents or mixed solvents thereof. Examples of the organic solvents include methylethylketone, isopropilalcohol, toluene, N-methylpyrrolidone (NMP), and methylisobutylketone.

The concentration of the polyurethane-based resin in a solution is appropriately determined, but is generally within a range of 5-50 wt. % and preferably 10-40 wt. % for a better coating condition onto a substrate to limit the possibility of foreign matter mixed therein or any failure in finish of coating due to uneven coating or hairs or brush-like marks. When less than 5 wt. %, the solution has an excessively low viscosity and is hard to be coated to a given film thickness by one stroke. When more than 50 wt. %, it has an excessively high viscosity and therefore is likely to cause a fault such as a roughly coated surface.

The thickness of the adhesive layer is preferably within a range of 100 nm-10 μm. When smaller than 100 ln, it is unlikely to produce a sufficient adhesive power. When greater than 10 μm, a problem may arise in manufacturing thin-profile or light-weight products, and the adhesive layer having such an excessive thickness itself may have birefringent characteristics, which poses the difficulty in producing an optical film having desirable birefringent characteristics.

It is not necessary to limit a coating technique of coating the polyurethane-based resin-containing solution onto the transparent polymer film to a specific technique. For example, it is possible to employ spin coating, roll coating, die coating, blade coating or any other conventional coating technique. By these techniques, the solution is coated on the transparent polymer film to have a given thickness, and the coated layer is then dried. Thus, the adhesive layer can be formed. The temperature for drying may be appropriately determined according to the kind of solvent or the like, but is usually in the range of 80-200° C., and preferably in the range of 100-150° C. The drying operation may be made at a constant temperature or alternatively made stepwisely while increasing the temperature. The time for drying operation is generally in the range of 5-30 minutes and preferably in the range of 10-20 minutes. When shorter than 5 minutes, a great amount of solvent may be left, which causes a problem in product reliability. When longer than 30 minutes, insufficient industrial productivity may be caused.

The birefringent layer is formed by coating a non-liquid crystal polymer and drying the same. The birefringent layer is usually designed to satisfy the relational expression (1): nx≧ny≧nz, in which nx, ny and nz respectively represent refractive indices in an X axis, a Y axis and a Z axis, of the birefringent layer. The X axis is an axis that gives a maximum in-plane refractive index. The Y axis is an in-plane axis perpendicular to the X axis, and the Z axis represents a thicknesswise direction perpendicular to the X axis and the Y axis. Unlike a liquid crystal material, a non-liquid crystal polymer allows itself to be optically uniaxial (namely nx>nz, ny>nz) due to its own characteristics, regardless of the orientation of a target film on which coating is to be made. Therefore, a target film and more specifically a film made up of a transparent polymer film and an urethane adhesive layer coated thereon is not required to have an orientation film coated or laminated on the surface of an urethane adhesive layer, even if it is an unoriented film. It is further possible to allow the film to be optically biaxial (namely nx>ny>nz) by stretching or shrinking the film while heating the same. When the birefringent layer satisfies the relative expression (1), it is possible to greatly enhance the contrast at oblique viewing angles when it is mounted in such as an LCD device of a vertical alignment (VA) mode. The nx, ny and nz are measured by using an automatic birefringence measuring apparatus (trade name KOBRA-21ADH, manufactured by Oji Scientific Instruments) at a wavelength of 590 nm and at a temperature of 25° C.

The birefringent layer is preferably designed to have the birefringence Δn(a) that satisfies the relative expression (2): Δn(a)>Δn(b)×10 when Δn(b) is the birefringence of the transparent polymer film; accordingly Δn(a)=nx(a)−nz(a), in which nx(a) and nz(a) respectively represent a maximum in-plane refractive index of the birefringent layer and a thicknesswise refractive index of the birefringent layer, and accordingly Δn(b)=nx(b)−nz(b), nx(b), in which nx(b) and nz(b) respectively represent a maximum in-plane refractive index of the transparent polymer film layer and a thicknesswise refractive index of the transparent polymer film layer. Herein, Δn is measured by the procedures described in the Examples. An optical film which satisfies the relative expression (2) significantly reduces uneven display when it is used in an image display device. Specifically, such an optical film is advantageous in that rainbow unevenness or the like is reduced in black display mode and hence the visibility is greatly improved.

For the non-liquid crystal polymer, it is preferable to use at least one polymer selected from the group consisting of polyamide, polyimide, polyester, polyetherketone, polyamideimide and polyesterimide, since these are excellent in heat resistance, chemical resistance, transparency and stiffness. These polymers may be used alone upon selection therefrom or used in mixture, for example, as a mixture of polyetherketone and polyamide or a mixture of two or more polymers respectively having functional groups different from each other. These polymers, which are excellent in heat resistance, chemical resistance and stiffness, enable a birefringent layer to be thinner, hence enabling an optical film to have a thin profile. Of these polymers, polyimide is particularly preferable because of its high transparency, high orientation and high stretchability.

The molecular weight of each of the aforesaid polymers is not necessarily limited, but for example the weight-average molecular weight (Mw) is preferably in the range of 1,000-1,000,000 and more preferably in the range of 2,000-500,000.

The polyimide is preferably of the type that has a high in-plane orientation and is soluble in organic solvent. Specifically, a polymer that includes a condensed polymer of 9,9-bis(aminoaryl)fluorene and an aromatic tetracarboxylic acid anhydride, having at least one repeat unit of the following formula (1), as disclosed in Japanese Patent Publication Tokuhyo 2000-511296.

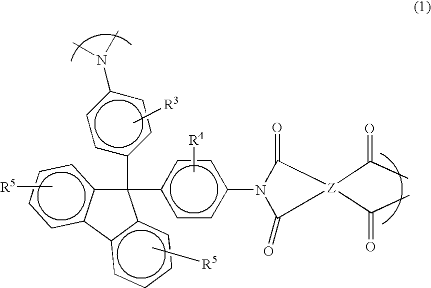

In the above formula (1), R³-R⁶ each are at least one substituent independently selected from the group consisting of hydrogen, halogen, phenyl or phenyl substituted with 1 to 4 halogen atoms or a C₁₋₁₀ (carbon numbers of 1-10) alkyl group, and a C₁₋₁₀ alkyl group, and R³-R⁶ each preferably are at least one substituent independently selected from the group consisting of halogen, phenyl or phenyl substituted with 1 to 4 halogen atoms or a C₁₋₁₀ alkyl group, and a C₁₋₁₀ alkyl group.

In the above formula (1), Z is for example a tetravalent aromatic group having 6 to 20 carbon atoms, and preferably a pyromellitic group, a polycyclic-aromatic group, derivatives of a polycyclic-aromatic group, or a group represented by the following formula (2).

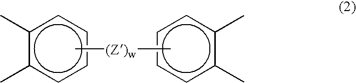

In the above formula (2), Z′ represents for example a covalent bond, a C(R⁷)₂ group, a CO group, an O atom, an S atom, an SO₂ group, an Si(C₂H₅)₂ group, or an NR⁸ group, and when there are plural Z's, they may be the same or different. W represents an integer from 1 to 10. R⁷ each are independently hydrogen or C(R⁹)₃. R⁸ is hydrogen, a C₁₋₂₀ aryl group, or a C₆₋₂₀ aryl group, and when it is plural, they may be the same or different. R⁹ each are independently hydrogen, fluorine or chlorine.

An example of the polycyclic-aromatic group includes a tetravalent group derived from naphthalene, fluorene, benzofluoren or anthracene. Examples of the derivatives of the polycyclic-aromatic group include the polycyclic-aromatic group substituted with at least one selected from the group consisting of a C₁₋₁₀ alkyl group, its fluorinated derivatives, and halogens such as F and Cl.

Further examples of the polymer include homopolymer having a repeat unit represented by the following formula (3) or (4), as described Japanese Patent Publication Tokuhyo Hei-8-511812. A polyimide of the following formula (5) is a preferable form of a homopolymer of the formula (3).

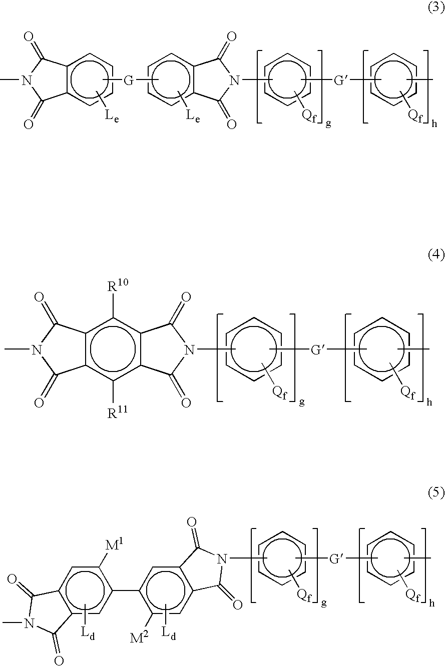

In the formulae (3)-(5), G and G′ each represent a group independently selected from the group consisting of, for example, a covalent bond, a CH₂ group, a C(CH₃)₂ group, a C(CF₃)₂ group, a C(CX₃)₂ group (herein, X represent halogen), a CO group, an O atom, an S atom, an SO₂ group, an Si(CH₂CH₂)₂ group, and an N(CH₃) group. They may be the same or different.

In the formulae (3) and (5), L represents a substituent, and d and e each represent the number of the corresponding substituent. L represents for example halogen, a C₁₋₃ alkyl group, a halogenated C₁₋₃ alkyl group, a phenyl group, or a substituted phenyl group, and when there are plural Ls, they may be the same or different. Examples of the substituted phenyl group include a substituted phenyl group having at least one substituent selected from the group consisting of halogen, a C₁₋₃ alkyl group, and a halogenated C₁₋₃ alkyl group. Examples of the halogen include fluorine, chlorine, bromine and iodine. d represents an integer from 0 to 2, and e represents an integer from 0 to 3.

In the above formulae (3)-(5), Q represents a substituent and f represents the number of substitutions thereof. An example of Q includes an atom or group selected from the group consisting of hydrogen, halogen, an alkyl group, a substituted alkyl group, a nitro group, a cyano group, a thioalkyl group, an alkoxy group, an aryl group, a substituted aryl group, an alkyl ester group, and a substituted alkyl ester group. When there are plural Qs, they may be the same or different. Examples of the halogen include fluorine, chlorine, bromine and iodine. An example of the substituted alkyl group includes a halogenated alkyl group. An example of the substituted aryl group includes a halogenated aryl group. In the formulae, f represents an integer from 0 to 4, and g and h respectively represent an integer from 0 to 3 and an integer from 1 to 3, in which g and h each are preferably greater than 1.

In the formula (4), R¹⁰ and R¹¹ each represent a group independently selected from the group consisting of hydrogen, halogen, a phenyl group, a substituted phenyl group, an alkyl group and a substituted alkyl group. R¹⁰ and R¹¹ each are preferably a halogenated alkyl group independently selected therefrom.

In the formula (5), M¹ and M² may the same or different, and examples of them include halogen, a C₁₋₃ alkyl group, a halogenated C₁₋₃ alkyl group, a phenyl group or a substituted phenyl group. Examples of the halogen include fluorine, chlorine, bromine and iodine. An example of the substituted phenyl group includes a substituted phenyl group having at least one substituent selected from the group consisting of halogen, a C₁₋₃ alkyl group, and a C₁₋₃ halogenated alkyl group.

An example of polyimide indicated in the formula (3) includes the one represented by the following formula (6).

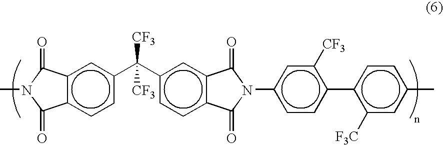

An example of the polyimide includes a copolymer prepared by appropriate copolymerization of dianhydride or diamine other than the aforesaid chemical architecture (repeat unit).

An example of the dianhydride includes aromatic tetracarboxilic dianhydride. Examples of the aromatic tetracarboxilic dianhydride include pyromellitic dianhydride, benzophenon tetracarboxylic dianhydrade, naphthalene tetracarboxylic dianhydride, heterocyclic aromatic tetracarboxylic dianhydride, and 2,2′-substituted biphenyl tetracarboxylic dianhydride.

Examples of the pyromellitic dianhydride include non-substituted pyromellitic dianhydride, 3,6-diphenyl pyromellitic dianhydride, 3,6-bis(trifluoromethyl)pyromellitic dianhydride, 3,6-dibromopyromellitic dianhydride, and 3,6-dichloropyromellitic dianhydride. Examples of the benzophenone tetracarboxylic dianhydride include 3,3′,4,4′-benzophenone tetracarboxylic dianhydride, 2,3,3′,4′-benzophenone tetracarboxylic dianhydride and 2,2′,3,3′-benzophenone tetracarboxylic dianhydride. Examples of the naphthalene tetracarboxylic dianhydride include 2,3,6,7-naphthalene-tetracarboxylic dianhydride, 1,2,5,6-naphthalene-tetracarboxylic dianhydride, and 2,6-dichloro-naphthalene-1,4,5,8-tetracarboxylic dianhydride. Examples of the heterocyclic aromatic tetracarboxylic dianhydride include thiophene-2, 3,4,5-tetracarboxylic dianhydride, pyrazine-2, 3,5,6-tetracarboxylic dianhydride and pyridine-2,3,5,6-tetracarboxylic dianhydride. Examples of the 2,2′-substituted biphenyl tetracarboxylic dianhydride include 2,2′-dibromo-4,4′,5,5′-biphenyl tetracarboxylic dianhydride, 2,2′-dichloro-4,4′,5,5′-biphenyl tetracarboxylic dianhydride and 2,2′-bis(trifluoromethyl)-4,4′,5, 5′-biphenyl tetracarboxylic dianhydride.

Other examples of the aromatic tetracarboxylic dianhydride may include 3,3′,4,4′-biphenyl tetracarboxylic dianhydride, bis(2,3-dicarboxyphenyl)methane dianhydride, bis(2,5,6-trifluoro-3,4-dicarboxyphenyl)methane dianhydride, 2,2-bis(3,4-dicarboxyphenyl)-1,1,1,3, 3,3-hexafluoropropane dianhydride, 4,4′ (3,4-dicarboxyphenyl)-2,2-diphenylpropane dianhydride, bis(3,4-dicarboxyphenyl)ether dianhydride, 4,4′-oxydiphthalic dianhydride, bis(3,4-dicarboxyphenyl)sulfonic dianhydride (3,3′,4,4′-diphenylsulfone tetracarboxylic dianhydride), 4,4′-[4,4′-isopropylidene-di(p-phenyleneoxy)]bis(phthalic dianhydride), N,N-(3,4-dicarboxyphenyl)-N-methylamine dianhydride and bis(3,4-dicarboxyphenyl)diethylsilane dianhydride.

Among the above, the aromatic tetracarboxylic dianhydride preferably is 2,2′-substituted biphenyl tetracarboxylic dianhydride, more preferably is 2,2′-bis(trihalomethyl)-4,4′,5,5′-biphenyl tetracarboxylic dianhydride, and further preferably is 2,2′-bis(trifluoromethyl)-4,4′,5,5′-biphenyl tetracarboxylic dianhydride.

The aforesaid diamine may be, for example, aromatic diamine. Specific examples thereof include benzenediamine, diaminobenzophenone, naphthalenediamine, heterocyclic aromatic diamine and other aromatic diamines.

The benzenediamine may be, for example, diamine selected from the group consisting of benzenediamines such as o-, m- or p-phenylenediamine, 2,4-diaminotoluene, 1,4-diamino-2-methoxybenzene, 1,4-diamino-2-phenylbenzene and 1,3-diamino-4-chlorobenzene. Examples of the diaminobenzophenone include 2,2′-diaminobenzophenone and 3,3′-diaminobenzophenone. The naphthalenediamine may be, for example, 1,8-diaminonaphthalene or 1,5-diaminonaphthalene. Examples of the heterocyclic aromatic diamine include 2,6-diaminopyridine, 2,4-diaminopyridine and 2,4-diamino-S-triazine.

Further, other than the above, the aromatic diamine may be 4,4′-diaminobiphenyl, 4,4′-diaminodiphenyl methane, 4,4′-(9-fluorenylidene)-dianiline, 2,2′-bis(trifluoromethyl)-4,4′-diaminobiphenyl, 3,3′-dichloro-4,4′-diaminodiphenyl methane, 2,2′-dichloro-4,4′-diaminobiphenyl, 2,2′, 5,5′-tetrachlorobenzidine, 2,2-bis(4-aminophenoxyphenyl)propane, 2,2-bis(4-aminophenyl)propane, 2,2-bis(4-aminophenyl)-1,1,1,3,3,3-hexafluoropropane, 4,4′-diamino diphenyl ether, 3,4′-diamino diphenyl ether, 1,3-bis(3-aminophenoxy)benzene, 1,3-bis(4-aminophenoxy)benzene, 1,4-bis(4-aminophenoxy)benzene, 4,4′-bis(4-aminophenoxy)biphenyl, 4,4′-bis(3-aminophenoxy)biphenyl, 2,2-bis [4(4-aminophenoxy)phenyl]propane, 2,2-bis [4-(4-aminophenoxy)phenyl]-1,1,1,3,3,3,-hexafluoropropane, 4,4′-diamino diphenyl thioether or 4,4′-diaminodiphenylsulfone.

The polyetherketone as a material for forming the birefringent layer may be, for example, polyaryletherketone represented by the general formula (7) below, which is disclosed in Japanese Patent Application Publication No. 2001-49110.

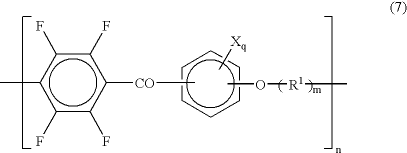

In the above formula (7), X represents a substituent, and q represents the number of substitutions therein. X is, for example, a halogen atom, a lower alkyl group, a halogenated alkyl group, a lower alkoxy group or a halogenated alkoxy group, and when there are plural Xs, they may be the same or different.

The halogen atom may be, for example, a fluorine atom, a bromine atom, a chlorine atom or an iodine atom, and among these, a fluorine atom is preferable. The lower alkyl group preferably is a C₁₋₆ lower straight alkyl group or a C₁₋₆ lower branched alkyl group and more preferably is, for example, a C₁₋₄ straight or branched chain alkyl group. More specifically, it is preferably a methyl group, an ethyl group, a propyl group, an isopropyl group, a butyl group, an isobutyl group, a sec-butyl group or a tert-butyl group, and particularly preferably a methyl group or an ethyl group. The halogenated alkyl group may be, for example, a halide of the aforesaid lower alkyl group such as a trifluoromethyl group. The lower alkoxy group is preferably a C₁₋₆ straight or branched chain alkoxy group and more preferably is, for example, a C₁₋₄ straight or branched chain alkoxy group. More specifically, it is further preferably a methoxy group, an ethoxy group, a propoxy group, an isopropoxy group, a butoxy group, an isobutoxy group, a sec-butoxy group or a tert-butoxy group, and particularly preferably a methoxy group or an ethoxy group. The halogenated alkoxy group may be, for example, a halide of the aforesaid lower alkoxy group such as a trifluoromethoxy group.

In the above formula (7), q is an integer from 0 to 4. In the formula (7), it is preferable that q=0 and a carbonyl group and an oxygen atom of an ether that are bonded to both ends of a benzene ring are present at para positions.

Also, in the above formula (7), R¹ is a group represented by the formula (8) below, and m is an integer of 0 or 1.

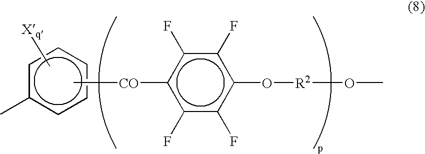

In the above formula (8), X′ is a substituent and is, for example, the same as X in the formula (7). In the formula (8), when there are plural X's, they may be the same or different. q′ indicates the number of substitutions in the X′ and is an integer from 0 to 4, preferably, q′=0. In addition, p is an integer of 0 or 1.

In the formula (8), R² represents a divalent aromatic group. This divalent aromatic group may be, for example, an o-, m- or p-phenylene group or a divalent group derived from naphthalene, biphenyl, anthracene, o-, m- or p-terphenyl, phenanthrene, dibenzofuran, biphenyl ether or biphenyl sulfone. In these divalent aromatic groups, hydrogen that is bonded directly to the aromatic may be substituted with a halogen atom, a lower alkyl group or a lower alkoxy group. Among them, the R² preferably is an aromatic group selected from the group consisting of the formulae (9) to (15) below.

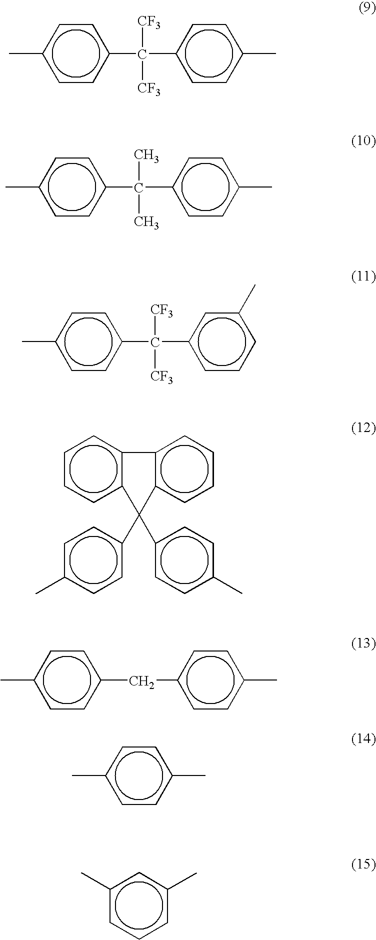

In the above formula (7), the R¹ is preferably a group represented by the formula (16) below, in which R² and p are equivalent to those in the aforesaid formula (8)

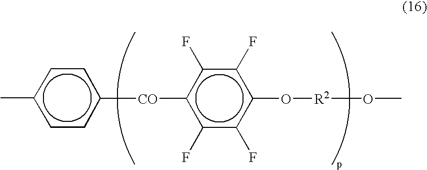

Furthermore, in the formula (7), n indicates a degree of polymerization ranging for example, from 2 to 5,000 and preferably from 5 to 500. The polymerization may be composed of repeating units having the same structure or different structures. In the latter case, the polymerization form of the repeating units may be a block polymerization or a random polymerization.

Moreover, it is preferable that an end on a p-tetrafluorobenzoylene group side of the polyaryletherketone represented by the formula (7) is fluorine and an end on an oxyalkylene group side thereof is a hydrogen atom. Such a polyaryletherketone can be represented by the general formula (17) below. In the formula below, n indicates a degree of polymerization as in the formula (7).

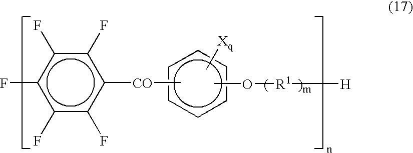

Specific examples of the polyaryletherketone represented by the formula (7) may include those represented by the formulae (18) to (21) below, in which n indicates a degree of polymerization as in the formula (7).

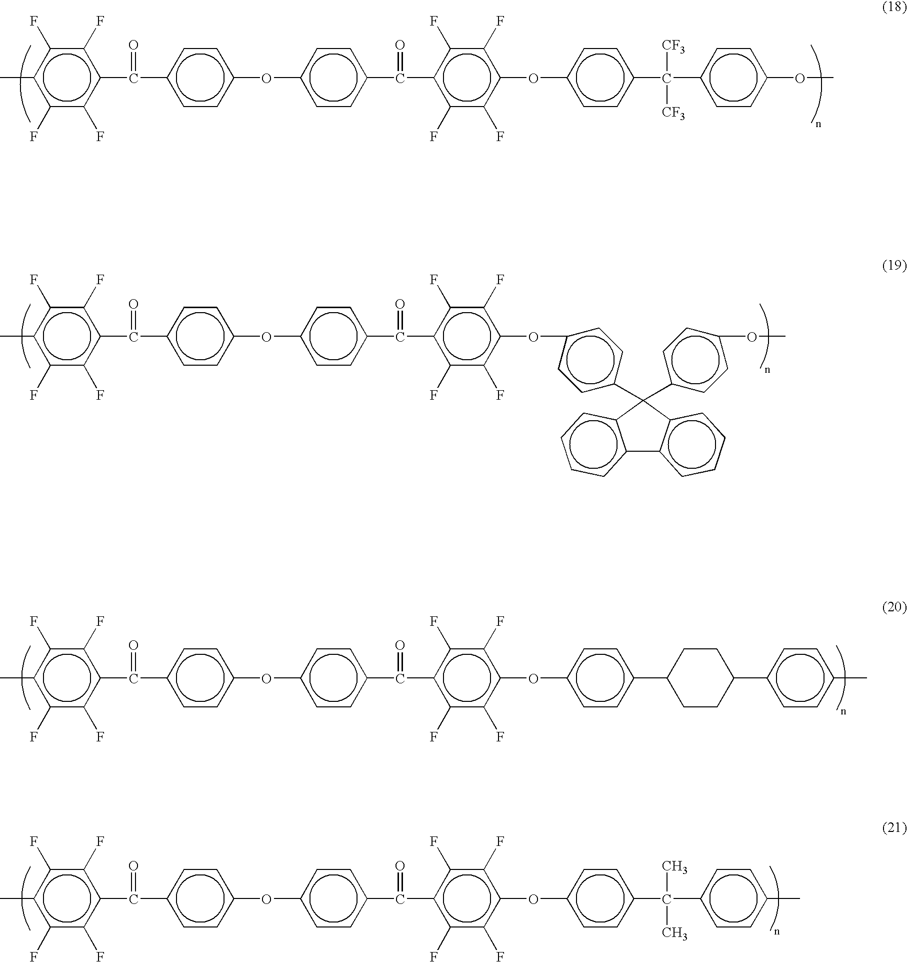

Other than the above, a non-liquid crystal polymer, namely the polyamide or polyester as a material for forming the birefringent layer may be, for example, polyamide or polyester described by Japanese Patent Publication Tokuhyo Hei-10-508048, and their repeating units can be represented by the general formula (22) below.

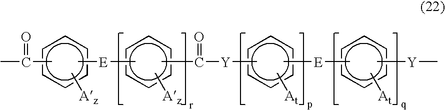

In the above formula (22), Y is O or NH. E is, for example, at least one group selected from the group consisting of a covalent bond, a C₂ alkylene group, a halogenated C₂ alkylene group, a CH₂ group, a C(CX₃)₂ group (herein X is halogen or hydrogen), a CO group, an O atom, an S atom, an SO₂ group, an Si(R)₂ group and an N(R) group, and Es may be the same or different. In the aforesaid E, R is at least one of a C₁₋₃ alkyl group and a halogenated C₁₋₃ alkyl group and presents at a meta position or a para position with respect to a carbonyl functional group or a Y group.

Further, in the above formula (22), A and A′ are substituents, and t and z respectively indicate the numbers of substitutions therein. Additionally, p is an integer from 0 to 3, q is an integer from 1 to 3, and r is an integer from 0 to 3.

The aforesaid A is selected from the group consisting of, for example, hydrogen, halogen, a C₁₋₃ alkyl group, a halogenated C₁₋₃ alkyl group, an alkoxy group represented by OR (wherein R is the group defined above), an aryl group, a substituted aryl group by halogenation, a C₁₋₉ alkoxycarbonyl group, a C₁₋₉ alkylcarbonyloxy group, a C₁₋₁₂ aryloxycarbonyl group, a C₁₋₁₂ arylcarbonyloxy group and a substituted derivative thereof, a C₁₋₁₂ arylcarbamoyl group, and a C₁₋₁₂ arylcarbonylamino group and a substituted derivative thereof. When there are plural As, they may be the same or different. The aforesaid A′ is selected from the group consisting of, for example, halogen, a C₁₋₃ alkyl group, a halogenated C₁₋₃ alkyl group, a phenyl group and a substituted phenyl group and when there are plural A's, they may be the same or different. A substituent on a phenyl ring of the substituted phenyl group can be, for example, halogen, a C₁₋₃ alkyl group, a halogenated C₁₋₃ alkyl group or a combination thereof. The t is an integer from 0 to 4, and the z is an integer from 0 to 3.

Among the repeating units of the polyamide or polyester represented by the formula (22) above, the repeating unit represented by the general formula (23) below is preferable.

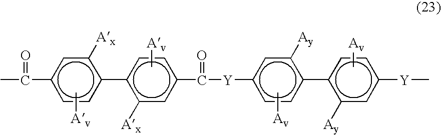

In the formula (23), A, A′ and Y are those defined by the formula (22), and v is an integer from 0 to 3, preferably is an integer from 0 to 2. Although each of x and y is 0 or 1, not both of them are 0.

The polyester may be the one having a repeating unit represented by the formulae (24) and (25).

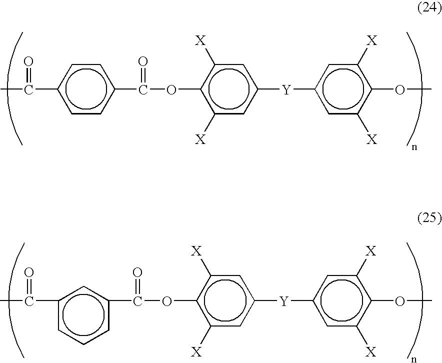

In the formulae (24) and (25), X and Y each represent a substituent. The X is selected from the group consisting of hydrogen, chlorine and bromine. The Y is selected from the group consisting of the formulae (26), (27), (28) and (29) below.

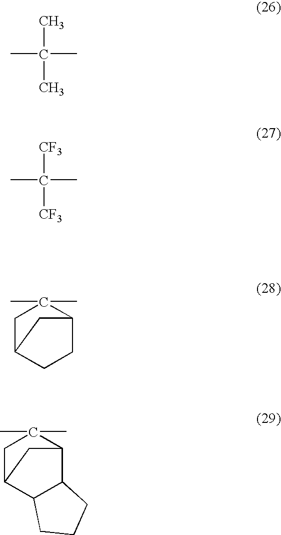

The polyester may be a copolymer combined with polyester represented in the formulae (24), (25).

In general, the birefringent layer is formed on an adhesive layer by coating a non-liquid crystal polymer as described above on the adhesive layer. While a technique of coating the non-liquid crystal polymer is not necessarily limited, preferable are a technique of coating by heat-melting the non-liquid crystal polymer, and a technique of coating by dissolving or dispersing the non-liquid crystal polymer in a solvent to prepare a non-liquid crystal polymer solution and coating the solution on the adhesive layer. Among them, the technique of coating the non-liquid crystal polymer solution is preferable because of its excellent workability.

Considering a viscosity allowing an easy coating, it is appropriate to prepare the polymer solution by mixing 5 to 50 wt. parts, preferably 10 to 40 wt. parts of the non-liquid crystal polymer in 100 wt. parts of the solvent, while there are no limitations on the viscosity.

The solvent of the non-liquid crystal polymer solution is not particularly limited as long as it can dissolve or suspend a forming material such as a non-liquid crystal polymer, and can be selected suitably according to the type of the non-liquid crystal polymer. Examples thereof include halogenated hydrocarbons such as chloroform, dichloromethane, carbon tetrachloride, dichloroethane, tetrachloroethane, trichloroethylene, tetrachloroethylene, chlorobenzene and orthodichlorobenzene; phenols such as phenol and parachlorophenol; aromatic hydrocarbons such as benzene, toluene, xylene, methoxybenzene and 1,2-dimethoxybenzene; ketone-based solvents such as acetone, methylethylketone, methylisobutylketone, cyclohexanone, cyclopentanone, 2-pyrrolidone and N-methyl-2-pyrrolidone; ester-based solvents such as ethyl acetate and butyl acetate; alcohol-based solvents such as t-butyl alcohol, glycerin, ethylene glycol, triethylene glycol, ethylene glycol monomethyl ether, diethylene glycol dimethyl ether, propylene glycol, dipropylene glycol and 2-methyl-2,4-pentanediol; amide-based solvents such as dimethylformamide and dimethylacetamide; nitrile-based solvents such as acetonitrile and butyronitrile; ether-based solvents such as diethyl ether, dibutyl ether and tetrahydrofuran; and carbon disulfide, ethyl cellosolve or butyl cellosolve. These solvents may be used alone or in combination of two or more.

Among the aforesaid solvents, a solvent that can solve a non-liquid crystal polymer is preferable. Among the solvents that can dissolve a non-liquid crystal polymer, methylisobutylketone is particularly preferable.

In general, a solvent that dissolves a non-liquid crystal polymer has a high dissolving power for polymer of a transparent polymer film layer, and therefore when such a solvent is used, it permeates through an adhesive layer and roughens or partially dissolves the surface of the transparent polymer film layer, with the result that many wrinkles or surface undulations occur in a laminated film. Particularly, this kind of problem becomes very significant when polyimide is used as a non-liquid crystal polymer, and a triacetylcellulose film is used as a transparent polymer film. While methylisobutylketone has an excellent dissolving power for a non-liquid crystal polymer (particularly for polyimide), it is highly unlikely to roughen the surface of a transparent polymer film (particularly a triacetylcellulose film). Therefore, when methylisobutylketone is used as a solvent, it is possible to produce a laminated film having a flat and smooth surface configuration with nearly no wrinkles or surface undulations.

Various additives such as stabilizers, plasticizers, metals or the like may be added into the non-liquid crystal polymer solution according to needs and circumstances.

Another resin may be added into the non-liquid crystal polymer solution in such a quantity that, for example, the orientation or other properties of a non-liquid crystal polymer is not significantly deteriorated. Examples of the resin to be added include a variety of commodity resins, engineering plastics, thermoplastic resins and thermosetting resins.

Examples of the commodity resin include polyethylene (PE), polypropylene (PP), polystyrene (PS), polymethylmethacrylate (PMMA), ABS resin, and AS resin. Examples of the engineering plastics include polyacetate (POM), polycarbonate (PC), polyamide (PA: nylon), polyethylene terephthalate (PET) and polybutylene terephthalate (PBT). Examples of the thermoplastic resins include polyphenylene sulfide (PPS), polyethersulfone (PES), polyketone (PK), polyimide (PI), polycyclohexane-dimethanol terephthalate (PCT), polyarylate (PAR) and liquid crystal polymers (LCP). Examples of the thermosetting resins include epoxy resins and phenol novolak resins.

When such a resin is added into the polymer solution, the quantity to be added is for example, not more than 50 wt. % and preferably not more than 30 wt. %, relative to the non-liquid crystal polymer.

Examples of the coating techniques of the non-liquid crystal polymer solution include spin coating, roll coating, flow coating, printing, dip coating, film flow expanding, bar coating and gravure printing. As for the coating, a polymer layer may be laminated according to needs and circumstances.

A film with the non-liquid crystal polymer solution coated thereon is subjected to, for example, a heat treatment so as to remove the solvent. The film is further subjected to the heat treatment and hence shrunken. This shrinking causes shrinking of the coated non-liquid crystal polymer film, thus forming a birefringent layer of a non-liquid crystal polymer. The conditions required for the above heat treatment are not necessarily limited, and therefore are appropriately determined according to the material or type of a transparent polymer film, while a heating temperature is generally within a range of 25-300° C., preferably within a range of 50-200° C. and more preferably within a range of 60-180° C.

The solvent left in the birefringent layer after the heat treatment may deteriorate the optical characteristics of an optical film with age in proportion to its quantity. In light of this, the residual quantity is preferably limited to not more than 5%, preferably not more than 2% and most preferably not more than 0.2%.

The film with the solvent removed therefrom is further subjected to a stretching treatment so as to give desirable optical characteristics such as to allow the film to be optically biaxial. The stretching technique is not necessarily limited. Examples of the stretching techniques include a free-end widthwise stretching to uniaxially stretch a film in the lengthwise direction with lateral ends kept free, a fixed-end widthwise stretching to uniaxially stretch a film in the widthwise direction, and a successive or simultaneous biaxial stretching technique to stretch a film both in the lengthwise direction and the widthwise direction.

These stretching treatments may be made by stretching both a transparent polymer film and a birefringent film (a coated film), while it is preferable to apply a stretching force only to the transparent polymer film for the reasons stated below.

When only the transparent polymer film is stretched, this stretching causes a tension force in the transparent polymer film and hence indirectly stretches the coated film. Since even stretching is generally achieved by stretching only the transparent polymer film rather than stretching it together with the coated film, stretching only the transparent polymer film enables even stretching of the coated film. During this stretching, the adhesive layer exhibits a sufficient adhesive power so as not to cause peeling of the coated film. Although the function is not still clear, a tension force evenly applied to the coated film can also reduce the variation in retardation of the coated film.

The conditions for the stretching are not limited, and therefore may be appropriately determined according to the type or the like of a transparent polymer film or a non-liquid crystal polymer. Specifically, the stretching ratio is preferably more than 1 time but not more than 5 times, more preferably more than 1 time but not more than 4 times, and most preferably more than 1 time but not more than 3 times. The temperature for the stretching treatment (stretching temperature) is preferably within a range of 80° C.-150° C., more preferably within a range of 90° C.-140° C., and most preferably within a range of 100° C.-130° C.

The thickness of the birefringent layer before or after the stretching is not necessarily limited, but it is generally within a range of 1-30 μm, preferably within a range of 2-20 μm, and more preferably within a range of 3-15 μm.

In an optical film of this embodiment, it is preferable that a transparent polymer film is preferably a polyacetylcellulose film or an HT film, while a birefringent layer is made of polyimide. A polyurethane-based resin has a significantly good adhesive power for a polyacetylcellulose film, an HT film and a birefringent layer made of polyimide, so that an optical film having this structure can have an adhesive layer highly rigidly adhered to a transparent polymer film and a birefringent layer. As a result, it is possible to further reduce the possibility that the transparent polymer film is separated from the birefringent layer.

The optical film of this embodiment may be combined with a polarizer to provide a polarizing plate. While there are no limitations on the polarizer, it is possible to use a polarizer prepared by making a variety of films absorb a dichroic substance such as iodine or a dye by a conventional method, and then dying, stretching, crosslinking and drying the film. Examples of films onto which the dichroic substance is absorbed include hydrophilic polymer films such as polyvinyl alcohol (PVA)-based films, partially-formalized PVA-based films, partially-saponified films based on ethylene-vinyl acetate copolymer and cellulose-based films. When the optical film of this embodiment is laminated with the polarizer to prepare a polarizing plate, an adhesive or the like may be used for the lamination. Examples of the adhesive include polymer pressure sensitive adhesive such as acrylic-based, vinyl alcohol-based, silicone-based, polyester-based, polyurethane-based or polyether-based adhesive, and rubber-based pressure sensitive adhesive. It is also possible to use adhesive made of an aqueous crosslinker of a vinyl alcohol-based polymer such as glutaraldehyde, melamine or oxalic acid.

An optical film of this embodiment or a polarizing plate that includes this optical film may be used as an optical film or a polarizing plate in an image display device such as an LCD device, an organic EL display device and a PDP. For example, the thus structured polarizing plate may be used as a polarizing plate to be mounted in an LCD device of a reflection type, an LCD device of a semi-transparent type, or an LCD device designed for both the transparent/reflection modes, all of which having a polarizing plate disposed on either side or both sides of a liquid crystal cell board. In an organic EL display device that contains an organic electro luminescence illuminant equipped with a transparent electrode on a surface side of an organic luminescence layer that emits light by impression of voltage, while being equipped with a metal electrode on a back side of the organic luminescence layer, the polarizing plate is used as a polarizing plate disposed on the surface side of the transparent electrode, or a retardation film installed between these transparent electrode and polarizing plate.

### EXAMPLES

Now, the detailed description will be made for the present invention with reference to Examples and Comparative Examples mentioned below. It is to be noted that the present invention is not limited to these Examples.

In the Examples and the Comparative Examples, the thickness of the adhesive layer and Δn were measured by the following procedures.

(Measurement of the Thickness of an Adhesive Layer)

The thickness of an adhesive layer was calculated based on optical interferometry in the wavelength range of 700-900 nm by using a recording spectrophotometer (trade name MCPD-2000, manufactured by Otsuka Denshi Co., Ltd.).

(Measurement of Δn)

Δn was measured by using an automatic birefringence measuring apparatus (trade name KOBRA-21ADH, manufactured by Oji Scientific Instruments) with a wavelength to be used for measurement set at 590 nm and a temperature for measurement set at 25° C.

(Measurement of Rth and Δnd)

A sample of 10 cm by 10 cm was prepared, and Rth and Δnd were measured at each of 10 points by using an automatic birefringence measuring apparatus (trade name KOBRA-21ADH, manufactured by Oji Scientific Instruments), and the average value and the variation around the average value for each of Rth and Δnd were calculated. Herein, Rth=(nx−nz)d, and Δnd=(nx−ny)d, in which d represents the thickness. The wavelength and the temperature for measurement were respectively set at 590 nm and 25° C.

### Example 1

A self-emulsifying, water-dispersible polyurethane resin (Linear polyurethane having a bisphenol A framework, trade name Bondtighter HUX320, manufactured by Asahi Electrochemicals K.K.) was mixed with a mixture as a solvent (dispersion medium) of water and isopropyl alcohol (weight ratio of 1:1) to prepare a 10 wt. % solution (dispersion medium) of a polyurethane-based resin, which was in turn coated on the entire surface of a triacetylcellulose film by gravure coating. Then, it was subjected to a heat treatment at a temperature of 120° C. for 10 minutes. Thus, a transparent, flat and smooth film having an adhesive layer and having a thickness of about 80 μm was obtained. The thickness of the adhesive layer was 3 μm.

Then, polyimide of Δnd≈0.04, which was synthesized from 2,2-bis(3,4-dicarboxyphenyl)hexafluoropropane≈6FDA and 2,2′-bis(trifluoromethyl)-4,4′-diaminobiphenyl≈PFMB≈TFMB, was dissolved by using cyclohexanone as a solvent so as to prepare a 23 wt. % solution of polyimide. Then, the solution was coated on the entire surface of the film, on which the adhesive layer was previously formed, by gravure coating. Then, it was subjected to a heat treatment at a temperature of 150° C. for 15 minutes, and then stretched to 1.3 times its original length at a temperature of 140° C. by a tenter stretching machine with both ends of the film gripped. Thus, a perfect transparent optical film having a birefringent layer was obtained. In the thus obtained optical film, the birefringent layer had a thickness of 6 μm, and the average value of Rth was 240 nm, and the average value of Δnd was 60 nm. The variation of Rth was within plus or minus 3 nm, and the variation of Δnd was within plus or minus 2 nm. The birefringent layer had an optically biaxial property of nx>ny>nz. This optical film had Δn(a) (i.e., Δn of a polyimide layer) of 0.045, and Δn(b) (i.e., Δn of a triacetylcellulose film layer) of 0.0006.

### Example 2

A polyester-based polyurethane resin containing aromatic polyester as a main component (trade name VYRON UR-1400, manufactured by Toyobo Co., Ltd.) was dissolved by using methylisobutylketone as a solvent so as to prepare a 5 wt. % solution of a polyester-based polyurethane resin, and the solution was coated on triacetylcellulose by gravure coating in the same manner as Example 1. Then, it was subjected to a heat treatment at a temperature of 120° C. for 10 minutes. Thus, a transparent, flat and smooth film having an adhesive layer was obtained. The thickness of the adhesive layer was 1 μm. Then, a perfect transparent optical film having a birefringent layer was obtained in the same manner as Example 1 except that the film obtained in this Example was used. In the thus obtained optical film, the thickness of the birefringent layer was 6 μm, the average value of Rth was 240 nm, and the average value of And was 60 nm. The variation of Rth was within plus or minus 3 nm, and the variation of Δnd was within plus or minus 2 nm. The birefringent layer had an optically biaxial property of nx>ny>nz.

### Example 3

A 5 wt. % solution of a polyester-based polyurethane resin used in the Example 2 was coated on a norbornene-based, transparent polymer film (trade name ARTON, manufactured by JSR Corporation) by gravure coating. Then, it was subjected to a heat treatment at a temperature of 120° C. for 10 minutes. Thus, a transparent, flat and smooth film having an adhesive layer and having a thickness of about 80 μm was obtained. The thickness of the adhesive layer was 0.5 μm. Then, a perfect transparent optical film having a birefringent layer was obtained in the same manner as Example 1 except that the film obtained in this Example was used. In the thus obtained optical film, the thickness of the birefringent layer was 6 μm, the average value of Rth was 240 nm, and the average value of Δnd was 60 nm.

The variation of Rth was within plus or minus 3 nm, and the variation of And was within plus or minus 2 nm. The birefringent layer had an optically biaxial property of nx>ny>nz.

### Example 4

A transparent, flat and smooth film having an adhesive layer was obtained in the same manner as Example 1 except that a self-emulsifying, water-dispersible polyurethane resin (trade name Bondtighter HUX320, manufactured by Asahi Electrochemicals K.K.) was used in place of a polyurethane resin of Example 1. The thickness of an adhesive layer was 3 μm. Then, a perfect transparent optical film having a birefringent layer was obtained in the same manner as Example 1 except that the film obtained in this Example was used. In the thus obtained optical film, the thickness of the birefringent layer was 6 μm, the average value of Rth was 240 nm, and the average value of Δnd was 60 nm. The variation of Rth was within plus or minus 3 nm, and the variation of And was within plus or minus 2 nm. The birefringent layer had an optically biaxial property of nx>ny>nz.

### Example 5

A triacetylcellulose film had opposite ends (each occupying about 5% of the entire surface area) with no adhesive layer and no birefringent layer formed thereon by coating, and these uncoated opposite ends were gripped, allowing only the triacetylcellulose film to be pulled and stretched. A perfect transparent optical film having a birefringent layer was obtained in the same manner as Example 1, except this stretching manner. In the thus obtained optical film, the thickness of the birefringent layer was 6 μm, the average value of Rth was 240 nm, and the average value of Δnd was 60 nm. The variation of Rth was within plus or minus 2 nm, and the variation of Δnd was within plus or minus 1 nm. The birefringent layer had an optically biaxial property of nx>ny>nz.

### Example 6

A transparent, flat and smooth film having an adhesive layer was obtained in the same manner as Example 1 except that methylethylketone was used as a solvent of the polyurethane-based resin solution of Example 2 in place of methylisobutylketone. The thickness of the adhesive layer was 0.5 μm. Then, a perfect transparent optical film having a birefringent layer was obtained in the same manner as Example 1 except that the film obtained in this Example was used. In the thus obtained optical film, the thickness of the birefringent layer was 6 μm, the average value of Rth was 240 nm, and the average value of Δnd was 60 nm. The variation of Rth was within plus or minus 3 nm, and the variation of Δnd was within plus or minus 2 nm. The birefringent layer had an optically biaxial property of nx>ny>nz.

### Example 7

A transparent, flat and smooth film having an adhesive layer was obtained in the same manner as Example 1 except that a self-emulsifying, water-dispersible polyurethane resin (trade name Bondtighter HUX523, manufactured by Asahi Electrochemicals K.K.) was used in place of a polyurethane resin of Example 1. The thickness of the adhesive layer was 3 μm. Then, a perfect transparent optical film having a birefringent layer was obtained in the same manner as Example 1 except that the film obtained in this Example was used. In the thus obtained optical film, the thickness of the birefringent layer was 6 μm, the average value of Rth was 240 nm, and the average value of Δnd was 60 nm. The variation of Rth was within plus or minus 3 nm, and the variation of Δnd was within plus or minus 2 nm. The birefringent layer had an optically biaxial property of nx>ny>nz.

### Example 8

A transparent, flat and smooth film having an adhesive layer was obtained in the same manner as Example 1 except that a self-emulsifying, water-dispersible polyester-based polyurethane resin (trade name Bondtighter HUX232, manufactured by Asahi Electrochemicals K.K.) was used in place of a polyurethane resin of Example 1. The thickness of the adhesive layer was 3 μm. Then, a perfect transparent optical film having a birefringent layer was obtained in the same manner as Example 1 except that the film obtained in this Example was used. In the thus obtained optical film, the thickness of the birefringent layer was 6 μm, the average value of Rth was 240 nm, and the average value of Δnd was 60 nm. The variation of Rth was within plus or minus 3 nm, and the variation of Δnd was within plus or minus 2 nm. The birefringent layer had an optically biaxial property of nx>ny>nz.

### Example 9

A transparent, flat and smooth film having an adhesive layer was obtained in the same manner as Example 1 except that a self-emulsifying, polyether-based polyurethane resin (trade name SUPERFLEX 130, manufactured by Dai-Ichi Kogyo Seiyaku CO., LTD.) was used in place of a polyurethane resin of Example 1. The thickness of the adhesive layer was 2 μm. Then, a perfect transparent optical film having a birefringent layer was obtained in the same manner as Example 1 except that the film obtained in this Example was used. In the thus obtained optical film, the thickness of the birefringent layer was 6 μm, the average value of Rth was 240 nm, and the average value of Δnd was 60 nm. The variation of Rth was within plus or minus 3 nm, and the variation of Δnd was within plus or minus 2 nm. The birefringent layer had an optically biaxial property of nx>ny>nz.

### Example 10

A transparent, flat and smooth film having an adhesive layer was obtained in the same manner as Example 1 except that a self-emulsifying, polyether-based polyurethane resin (trade name SUPERFLEX 600, manufactured by Dai-Ichi Kogyo Seiyaku CO., LTD.) was used in place of a polyurethane resin of Example 1. The thickness of the adhesive layer was 2 μm. Then, a perfect transparent optical film having a birefringent layer was obtained in the same manner as Example 1 except that the film obtained in this Example was used. In the thus obtained optical film, the thickness of the birefringent layer was 6 μm, the average value of Rth was 240 nm, and the average value of Δnd was 60 nm. The variation of Rth was within plus or minus 3 nm, and the variation of Δnd was within plus or minus 2 nm. The birefringent layer had an optically biaxial property of nx>ny>nz.

### Example 11

A transparent, flat and smooth film having an adhesive layer was obtained in the same manner as Example 1 except that a self-emulsifying, polycarbonate-based polyurethane resin (trade name SUPERFLEX 410, manufactured by Dai-Ichi Kogyo Seiyaku CO., LTD.) was used in place of a polyurethane resin of Example 1. The thickness of the adhesive layer was 1 μm. Then, a perfect transparent optical film having a birefringent layer was obtained in the same manner as Example 1 except that the film obtained in this Example was used. In the thus obtained optical film, the thickness of the birefringent layer was 6 μm, the average value of Rth was 240 nm, and the average value of Δnd was 60 nm. The variation of Rth was within plus or minus 3 nm, and the variation of Δnd was within plus or minus 2 nm. The birefringent layer had an optically biaxial property of nx>ny>nz.

### Example 12

A transparent, flat and smooth film having an adhesive layer was obtained in the same manner as Example 1 except that a self-emulsifying, polycarbonate-based polyurethane resin (trade name SUPERFLEX 420, manufactured by Dai-Ichi Kogyo Seiyaku CO., LTD.) was used in place of a polyurethane resin of Example 1. The thickness of the adhesive layer was 1 μm. Then, a perfect transparent optical film having a birefringent layer was obtained in the same manner as Example 1 except that the film obtained in this Example was used. In the thus obtained optical film, the thickness of the birefringent layer was 6 μm, the average value of Rth was 240 nm, and the average value of Δnd was 60 nm. The variation of Rth was within plus or minus 3 nm, and the variation of Δnd was within plus or minus 2 nm. The birefringent layer had an optically biaxial property of nx>ny>nz.

### Example 13

A transparent, flat and smooth film having an adhesive layer was obtained in the same manner as Example 1 except that a self-emulsifying, polycarbonate-based polyurethane resin (trade name SUPERFLEX 460, manufactured by Dai-Ichi Kogyo Seiyaku CO., LTD.) was used in place of a polyurethane resin of Example 1. The thickness of the adhesive layer was 1 μm. Then, a perfect transparent optical film having a birefringent layer was obtained in the same manner as Example 1 except that the film obtained in this Example was used. In the thus obtained optical film, the thickness of the birefringent layer was 6 μm, the average value of Rth was 240 nm, and the average value of Δnd was 60 nm. The variation of Rth was within plus or minus 3 nm, and the variation of Δnd was within plus or minus 2 nm. The birefringent layer had an optically biaxial property of nx>ny>nz.

### Example 14

A transparent, flat and smooth film having an adhesive layer was obtained in the same manner as Example 1 except that a nonself-emulsifying, polyester-based polyurethane resin (trade name SUPERFLEX E2000, manufactured by Dai-Ichi Kogyo Seiyaku CO., LTD.) was used in place of a polyurethane resin of Example 1. The thickness of the adhesive layer was 2 μm. Then, a perfect transparent optical film having a birefringent layer was obtained in the same manner as Example 1 except that the film obtained in this Example was used. In the thus obtained optical film, the thickness of the birefringent layer was 6 μm, the average value of Rth was 240 nm, and the average value of Δnd was 60 nm. The variation of Rth was within plus or minus 3 nm, and the variation of And was within plus or minus 2 nm. The birefringent layer had an optically biaxial property of nx>ny>nz.

### Example 15

A transparent, flat and smooth film having an adhesive layer was obtained in the same manner as Example 1 except that a nonself-emulsifying, polyester-based polyurethane resin (trade name BONDIC 1250, manufactured by Dainippon Ink And Chemicals, Incorporated) was used in place of a polyurethane resin of Example 1, and a mixture of water and toluene (weight ratio of 1:1) was used as its solvent (dispersion medium). The thickness of the adhesive layer was 3 μm. Then, a perfect transparent optical film having a birefringent layer was obtained in the same manner as Example 1 except that the film obtained in this Example was used. In the thus obtained optical film, the thickness of the birefringent layer was 6 μm, the average value of Rth was 240 nm, and the average value of Δnd was 60 nm. The variation of Rth was within plus or minus 3 nm, and the variation of Δnd was within plus or minus 2 nm. The birefringent layer had an optically biaxial property of nx>ny>nz.

### Example 16

A transparent, flat and smooth film having an adhesive layer was obtained in the same manner as Example 1 except that a nonself-emulsifying, polyether-based polyurethane resin (trade name BONDIC 1310 NSA, manufactured by Dainippon Ink And Chemicals, Incorporated) was used in place of a polyurethane resin of Example 1, and only water was used as its solvent (dispersion medium). The thickness of the adhesive layer was 3 μm. Then, a perfect transparent optical film having a birefringent layer was obtained in the same manner as Example 1 except that the film obtained in this Example was used. In the thus obtained optical film, the thickness of the birefringent layer was 6 μm, the average value of Rth was 240 nm, and the average value of Δnd was 60 nm. The variation of Rth was within plus or minus 3 nm, and the variation of Δnd was within plus or minus 2 nm. The birefringent layer had an optically biaxial property of nx>ny>nz.

### Example 17

A transparent, flat and smooth film having an adhesive layer was obtained in the same manner as Example 1 except that a nonself-emulsifying, polyether-based polyurethane resin (trade name BONDIC 1320 NS, manufactured by Dainippon Ink And Chemicals, Incorporated) was used in place of a polyurethane resin of Example 1, and only water was used as its solvent (dispersion medium). The thickness of the adhesive layer was 3 μm. Then, a perfect transparent optical film having a birefringent layer was obtained in the same manner as Example 1 except that the film obtained in this Example was used. In the thus obtained optical film, the thickness of the birefringent layer was 6 μm, the average value of Rth was 240 nm, and the average value of Δnd was 60 nm. The variation of Rth was within plus or minus 3 nm, and the variation of Δnd was within plus or minus 2 nm. The birefringent layer had an optically biaxial property of nx>ny>nz.

### Example 18

A transparent, flat and smooth film having an adhesive layer was obtained in the same manner as Example 1 except that a nonself-emulsifying, polyether-based polyurethane resin (trade name BONDIC 1510, manufactured by Dainippon Ink And Chemicals, Incorporated) was used in place of a polyurethane resin of Example 1, and a mixture of water and toluene (weight ratio of 1:1) was used as its solvent (dispersion medium). The thickness of the adhesive layer was 3 μm. Then, a perfect transparent optical film having a birefringent layer was obtained in the same manner as Example 1 except that the film obtained in this Example was used. In the thus obtained optical film, the thickness of the birefringent layer was 6 μm, the average value of Rth was 240 nm, and the average value of Δnd was 60 nm. The variation of Rth was within plus or minus 3 nm, and the variation of Δnd was within plus or minus 2 nm. The birefringent layer had an optically biaxial property of nx>ny>nz.

### Example 19

A transparent, flat and smooth film having an adhesive layer was obtained in the same manner as Example 1 except that a nonself-emulsifying, polyester-based polyurethane resin (trade name HYDRAN HW-980, manufactured by Dainippon Ink And Chemicals, Incorporated) was used in place of a polyurethane resin of Example 1, and a mixture of water, acetone and NMP (weight ratio of 1:0.5:0.5) was used as its solvent (dispersion medium). The thickness of the adhesive layer was 3 μm. Then, a perfect transparent optical film having a birefringent layer was obtained in the same manner as Example 1 except that the film obtained in this Example was used. In the thus obtained optical film, the thickness of the birefringent layer was 6 μm, the average value of Rth was 240 nm, and the average value of Δnd was 60 nm. The variation of Rth was within plus or minus 3 nm, and the variation of Δnd was within plus or minus 2 nm. The birefringent layer had an optically biaxial property of nx>ny>nz.

### Example 20

A transparent, flat and smooth film having an adhesive layer was obtained in the same manner as Example 1 except that a nonself-emulsifying, polyester-based polyurethane resin (trade name HYDRAN APX-101H, manufactured by Dainippon Ink And Chemicals, Incorporated) was used in place of a polyurethane resin of Example 1, and only water was used as its solvent (dispersion medium). The thickness of the adhesive layer was 3 μm. Then, a perfect transparent optical film having a birefringent layer was obtained in the same manner as Example 1 except that the film obtained in this Example was used. In the thus obtained optical film, the thickness of the birefringent layer was 6 μm, the average value of Rth was 240 nm, and the average value of Δnd was 60 nm. The variation of Rth was within plus or minus 3 nm, and the variation of Δnd was within plus or minus 2 nm. The birefringent layer had an optically biaxial property of nx>ny>nz.

### Example 21

A transparent, flat and smooth film having an adhesive layer was obtained in the same manner as Example 1 except that a nonself-emulsifying, polyester-based polyurethane resin (trade name SPENSOL L512, manufactured by Dainippon Ink And Chemicals, Incorporated) was used in place of a polyurethane resin of Example 1, and a mixture of water and NMP (weight ratio of 1:1) was used as its solvent (dispersion medium). The thickness of the adhesive layer was 3 μm. Then, a perfect transparent optical film having a birefringent layer was obtained in the same manner as Example 1 except that the film obtained in this Example was used. In the thus obtained optical film, the thickness of the birefringent layer was 6 μm, the average value of Rth was 240 nm, and the average value of Δnd was 60 nm. The variation of Rth was within plus or minus 3 nm, and the variation of Δnd was within plus or minus 2 nm. The birefringent layer had an optically biaxial property of nx>ny>nz.

### Examples 22-42

Perfect transparent optical films respectively having birefringent layers were obtained in the same manner as Examples 1-21 except that methylisobutylketone was used as a solvent of a polyimide solution in each of Examples 1-21 in place of cyclohexanone. The thickness of the birefringent layer, the average value of Rth, the average value of Δnd, the variation of Rth and variation of Δnd of each of Examples 22-42 were the same as those of the corresponding Example. An optical film of Example 22 had Δn(a) (i.e., Δn of a polyimide layer) of 0.045, and Δn(b) (i.e., Δn of a triacetylcellulose film) of 0.0006.

### Comparative Example 1

A perfect transparent optical film having a birefringent layer was obtained in the same manner as Example 1 except that a triacetylcellulose film was used without forming thereon an adhesive layer. In the thus obtained optical film, the thickness of the birefringent layer was 6 μm, the average value of Rth was 240 nm, and the average value of Δnd was 60 nm. The variation of Rth was within plus or minus 10 nm, and the variation of Δnd was within plus or minus 5 nm. The birefringent layer had an optically biaxial property of nx>ny>nz.

### Comparative Example 2

A perfect transparent optical film having a birefringent layer was obtained in the same manner as Example 1 except that an adhesive layer was not formed and a norbornene-based transparent polymer film was used in place of a triacetylcellulose film. In the thus obtained optical film, the thickness of the birefringent layer was 6 μm, the average value of Rth was 240 nm, and the average value of Δnd was 60 nm. The variation of Rth was within plus or minus 10 nm, and the variation of Δnd was within plus or minus 5 nm. The birefringent layer had an optically biaxial property of nx>ny>nz.

### Comparative Example 3

A perfect transparent optical film having a birefringent layer was obtained in the same manner as Example 1 except that a water-dispersible polymeric polyester (trade name VYLONAL MD-1400, manufactured by Toyobo Co., Ltd.) was used in place of a polyurethane-based resin as a resin for forming an adhesive layer, and water was used as its solvent (dispersion medium). In the thus obtained optical film, the thickness of the birefringent layer was 6 μm, the variation of Rth was within plus or minus 7 nm, and the variation of Δnd was within plus or minus 4 nm. The birefringent layer had an optically biaxial property of nx>ny>nz.

### Comparative Example 4

A perfect transparent optical film having a birefringent layer was obtained in the same manner as Example 1 except that a water-dispersible polymeric polyester (trade name VYLONAL MD-1100, manufactured by Toyobo Co., Ltd.) was used in place of a polyurethane-based resin as a resin for forming an adhesive layer, and water was used as its solvent (dispersion medium). In the thus obtained optical film, the thickness of the birefringent layer was 6 μm, the variation of Rth was within plus or minus 7 nm, and the variation of Δnd was within plus or minus 4 nm. The birefringent layer had an optically biaxial property of nx>ny>nz.

### Comparative Example 5

A perfect transparent optical film having a birefringent layer was obtained in the same manner as Example 1 except that polyisocyanate (trade name AQUANATE 100, manufactured by Nippon Polyurethane Industry Co., Ltd.) was used in place of a polyurethane-based resin as a resin for forming an adhesive layer, and water was used as its solvent (dispersion medium). In the thus obtained optical film, the thickness of the birefringent layer was 6 μm, the variation of Rth was within plus or minus 7 nm, and the variation of Δnd was within plus or minus 4 nm. The birefringent layer had an optically biaxial property of nx>ny>nz.

### Comparative Example 6

A perfect transparent optical film having a birefringent layer was obtained in the same manner as Example 1 except that isocyanate (trade name DURANATE TPA-100, manufactured by Asahi Kasei Corporation) was used in place of a polyurethane-based resin as a resin for forming an adhesive layer, and water was used as its solvent (dispersion medium). In the thus obtained optical film, the thickness of the birefringent layer was 6 μm, the variation of Rth was within plus or minus 7 nm, and the variation of Δnd was within plus or minus 4 nm. The birefringent layer had an optically biaxial property of nx>ny>nz.

### Comparative Example 7

A perfect transparent optical film having a birefringent layer was obtained in the same manner as Example 1 except that aromatic polyester (trade name FINETEX ES2000, manufactured by Dainippon Ink And Chemicals, Incorporated) was used in place of a polyurethane-based resin as a resin for forming an adhesive layer, and a mixture of water and N-methylpyridon (weight ratio of 1:1) was used as its solvent (dispersion medium). In the thus obtained optical film, the thickness of the birefringent layer was 6 μm, the variation of Rth was within plus or minus 7 nm, and the variation of Δnd was within plus or minus 4 nm. The birefringent layer had an optically biaxial property of nx>ny>nz.

### Comparative Example 8

First, a 23 wt. % solution of polyimide was prepared in the same manner as Example 1, which was then coated on the entire surface of a polyethylene terephthalate film by gravure coating. Then, the coated film was subjected to a heat treatment at a temperature of 150° C. for 15 minutes, and then stretched to 1.3 times its original width in a widthwise direction at a temperature of 140° C. by a tenter stretching machine with both ends of the film gripped. Thus, a birefringent film was formed on the polyethylene terephthalate film.

Then, a 10 wt. % solution (dispersion liquid) of a polyurethane-based resin was prepared in the same manner as Example 1, which was then coated on the entire surface of a triacetylcellulose film. Then, the surface of the birefringent layer of the polyethylene terephthalate film was bonded to the polyurethane-based resin solution coated surface of the triacetylcellulose film. Then, the bonded films were subjected to a heat treatment at a temperature of 120° C. for 10 minutes, and then the polyethylene terephthalate film was peeled away from the triacetylcellulose film. Thus, a perfect transparent optical film having the triacetylcellulose film with an adhesive layer and a birefringent layer laminated thereon was obtained. In the thus obtained optical film, the thickness of the birefringent layer was 6 μm, the variation of Rth was within plus or minus 10 nm, and the variation of Δnd was within plus or minus 5 nm. The birefringent layer had an optically biaxial property of nx>ny>nz.

### Comparative Examples 9-16

Perfect transparent optical films respectively having birefringent layers were obtained in the same manner as Comparative Examples 1-8 except that methylisobutylketone was used as a solvent of a polyimide solution in each of Examples 1-8 in place of cyclohexanone. The thickness of the birefringent layer, the average value of Rth, the average value of Δnd, the variation of Rth and the variation of Δnd of each of Comparative Examples 1-8 were the same as those of the corresponding Comparative Example. Each of the birefringent layers had an optically biaxial property of nx>ny>nz.

### Test Example 1

The optical films of the above Examples and the Comparative Examples were tested as stated below. The test results are shown in TABLE 1.

(Adhesion Test)

Films were evaluated and classified into 6 grades, namely 0, 2, 4, 6, 8 and 10 based on a grid pattern tape friction test given in JIS K-5400-1990. The results are shown in TABLE 1, in which a greater number of the evaluation indicates a better adhesive power.

TABLE 1

| | | | | THICK- | | | |
|---|---|---|---|---|---|---|---|
| | | | | NESS | | | |
| | | | | OF AN | | VARI- | VARI- |
| | | | | ADHE- | | ATION | ATION |
| | | | SOLVENT OF A | SIVE | ADHE- | OF | OF |
| | | COMPONENT OF AN | BIREFRINGENT | LAYER | SIVE | Δnd | Rth |
| | SUBSTRATE FILM | ADHESIVE LAYER | LAYER | μM | POWER | NM | NM |
| EXAMPLE 1 | TRIACETYLCELLULOSE | POLYURETHANE RESIN\textcircled{1} | CYCLOHEXANONE | 3 | 10 | ±2 | ±3 |
| | FILM | | | | | | |
| EXAMPLE 2 | TRIACETYLCELLULOSE | POLYESTER-BASED | CYCLOHEXANONE | 1 | 10 | ±2 | ±3 |
| | FILM | POLYURETHANE RESIN\textcircled{1} | | | | | |
| EXAMPLE 3 | NORBORNENE-BASED | POLYESTER-BASED | CYCLOHEXANONE | 0.5 | 10 | ±2 | ±3 |
| | FILM | POLYURETHANE RESIN\textcircled{1} | | | | | |
| EXAMPLE 4 | TRIACETYLCELLULOSE | POLYURETHANE RESIN\textcircled{2} | CYCLOHEXANONE | 3 | 10 | ±2 | ±3 |
| | FILM | | | | | | |
| EXAMPLE 5 | TRIACETYLCELLULOSE | POLYURETHANE RESIN\textcircled{1} | CYCLOHEXANONE | 3 | 10 | ±1 | ±2 |
| | FILM | | | | | | |
| EXAMPLE 6 | TRIACETYLCELLULOSE | POLYESTER-BASED | CYCLOHEXANONE | 0.5 | 10 | ±2 | ±3 |
| | FILM | POLYURETHANE RESIN\textcircled{1} | | | | | |
| EXAMPLE 7 | TRIACETYLCELLULOSE | POLYURETHANE RESIN\textcircled{3} | CYCLOHEXANONE | 3 | 10 | ±2 | ±3 |
| | FILM | | | | | | |
| EXAMPLE 8 | TRIACETYLCELLULOSE | POLYESTER-BASED | CYCLOHEXANONE | 3 | 10 | ±2 | ±3 |
| | FILM | POLYURETHANE RESIN\textcircled{2} | | | | | |
| EXAMPLE 9 | TRIACETYLCELLULOSE | POLYETHER-BASED | CYCLOHEXANONE | 2 | 10 | ±2 | ±3 |
| | FILM | POLYURETHANE RESIN\textcircled{1} | | | | | |
| EXAMPLE 10 | TRIACETYLCELLULOSE | POLYETHER-BASED | CYCLOHEXANONE | 2 | 10 | ±2 | ±3 |
| | FILM | POLYURETHANE RESIN\textcircled{2} | | | | | |
| EXAMPLE 11 | TRIACETYLCELLULOSE | POLYCARBONATE-BASED | CYCLOHEXANONE | 1 | 10 | ±2 | ±3 |
| | FILM | POLYURETHANE RESIN\textcircled{1} | | | | | |
| EXAMPLE 12 | TRIACETYLCELLULOSE | POLYCARBONATE-BASED | CYCLOHEXANONE | 1 | 10 | ±2 | ±3 |
| | FILM | POLYURETHANE RESIN\textcircled{2} | | | | | |
| EXAMPLE 13 | TRIACETYLCELLULOSE | POLYCARBONATE-BASED | CYCLOHEXANONE | 1 | 10 | ±2 | ±3 |
| | FILM | POLYURETHANE RESIN\textcircled{3} | | | | | |
| EXAMPLE 14 | TRIACETYLCELLULOSE | POLYESTER-BASED | CYCLOHEXANONE | 2 | 10 | ±2 | ±3 |
| | FILM | POLYURETHANE RESIN\textcircled{3} | | | | | |
| EXAMPLE 15 | TRIACETYLCELLULOSE | POLYESTER-BASED | CYCLOHEXANONE | 3 | 10 | ±2 | ±3 |
| | FILM | POLYURETHANE RESIN\textcircled{4} | | | | | |
| EXAMPLE 16 | TRIACETYLCELLULOSE | POLYETHER-BASED | CYCLOHEXANONE | 3 | 10 | ±2 | ±3 |
| | FILM | POLYURETHANE RESIN\textcircled{3} | | | | | |
| EXAMPLE 17 | TRIACETYLCELLULOSE | POLYETHER-BASED | CYCLOHEXANONE | 3 | 10 | ±2 | ±3 |
| | FILM | POLYURETHANE RESIN\textcircled{4} | | | | | |
| EXAMPLE 18 | TRIACETYLCELLULOSE | POLYETHER-BASED | CYCLOHEXANONE | 3 | 10 | ±2 | ±3 |
| | FILM | POLYURETHANE RESIN\textcircled{5} | | | | | |
| EXAMPLE 19 | TRIACETYLCELLULOSE | POLYESTER-BASED | CYCLOHEXANONE | 3 | 10 | ±2 | ±3 |
| | FILM | POLYURETHANE RESIN\textcircled{5} | | | | | |
| EXAMPLE 20 | TRIACETYLCELLULOSE | POLYESTER-BASED | CYCLOHEXANONE | 3 | 10 | ±2 | ±3 |
| | FILM | POLYURETHANE RESIN\textcircled{6} | | | | | |
| EXAMPLE 21 | TRIACETYLCELLULOSE | POLYESTER-BASED | CYCLOHEXANONE | 3 | 10 | ±2 | ±3 |
| | FILM | POLYURETHANE RESIN\textcircled{7} | | | | | |
| EXAMPLE 22 | TRIACETYLCELLULOSE | POLYURETHANE RESIN\textcircled{1} | METHYLISOBUTYL- | 3 | 10 | ±2 | ±3 |
| | FILM | | KETONE | | | | |
| EXAMPLE 23 | TRIACETYLCELLULOSE | POLYESTER-BASED | METHYLISOBUTYL- | 1 | 10 | ±2 | ±3 |
| | FILM | POLYURETHANE RESIN\textcircled{1} | KETONE | | | | |
| EXAMPLE 24 | NORBORNENE-BASED | POLYESTER-BASED | METHYLISOBUTYL- | 0.5 | 10 | ±2 | ±3 |
| | FILM | POLYURETHANE RESIN\textcircled{1} | KETONE | | | | |
| EXAMPLE 25 | TRIACETYLCELLULOSE | POLYURETHANE RESIN\textcircled{2} | METHYLISOBUTYL- | 3 | 10 | ±2 | ±3 |
| | FILM | | KETONE | | | | |
| EXAMPLE 26 | TRIACETYLCELLULOSE | POLYURETHANE-BASED | METHYLISOBUTYL- | 3 | 10 | ±1 | ±2 |
| | FILM | RESIN\textcircled{1} | KETONE | | | | |
| EXAMPLE 27 | TRIACETYLCELLULOSE | POLYESTER-BASED | METHYLISOBUTYL- | 0.5 | 10 | ±2 | ±3 |
| | FILM | POLYURETHANE RESIN\textcircled{1} | KETONE | | | | |
| EXAMPLE 28 | TRIACETYLCELLULOSE | POLYURETHANE RESIN\textcircled{3} | METHYLISOBUTYL- | 3 | 10 | ±2 | ±3 |
| | FILM | | KETONE | | | | |
| EXAMPLE 29 | TRIACETYLCELLULOSE | POLYESTER-BASED | METHYLISOBUTYL- | 3 | 10 | ±2 | ±3 |
| | FILM | POLYURETHANE RESIN\textcircled{2} | KETONE | | | | |
| EXAMPLE 30 | TRIACETYLCELLULOSE | POLYETHER-BASED | METHYLISOBUTYL- | 2 | 10 | ±2 | ±3 |
| | FILM | POLYURETHANE RESIN\textcircled{1} | KETONE | | | | |
| EXAMPLE 31 | TRIACETYLCELLULOSE | POLYETHER-BASED | METHYLISOBUTYL- | 2 | 10 | ±2 | ±3 |
| | FILM | POLYURETHANE RESIN\textcircled{2} | KETONE | | | | |
| EXAMPLE 32 | TRIACETYLCELLULOSE | POLYCARBONATE-BASED | METHYLISOBUTYL- | 1 | 10 | ±2 | ±3 |
| | FILM | POLYURETHANE RESIN\textcircled{1} | KETONE | | | | |
| EXAMPLE 33 | TRIACETYLCELLULOSE | POLYCARBONATE-BASED | METHYLISOBUTYL- | 1 | 10 | ±2 | ±3 |
| | FILM | POLYURETHANE RESIN\textcircled{2} | KETONE | | | | |
| EXAMPLE 34 | TRIACETYLCELLULOSE | POLYCARBONATE-BASED | METHYLISOBUTYL- | 1 | 10 | ±2 | ±3 |
| | FILM | POLYURETHANE RESIN\textcircled{3} | KETONE | | | | |
| EXAMPLE 35 | TRIACETYLCELLULOSE | POLYESTER-BASED | METHYLISOBUTYL- | 2 | 10 | ±2 | ±3 |
| | FILM | POLYURETHANE RESIN\textcircled{3} | KETONE | | | | |
| EXAMPLE 36 | TRIACETYLCELLULOSE | POLYESTER-BASED | METHYLISOBUTYL- | 3 | 10 | ±2 | ±3 |
| | FILM | POLYURETHANE RESIN\textcircled{4} | KETONE | | | | |
| EXAMPLE 37 | TRIACETYLCELLULOSE | POLYETHER-BASED | METHYLISOBUTYL- | 3 | 10 | ±2 | ±3 |
| | FILM | POLYURETHANE RESIN\textcircled{3} | KETONE | | | | |
| EXAMPLE 38 | TRIACETYLCELLULOSE | POLYETHER-BASED | METHYLISOBUTYL- | 3 | 10 | ±2 | ±3 |
| | FILM | POLYURETHANE RESIN\textcircled{4} | KETONE | | | | |
| EXAMPLE 39 | TRIACETYLCELLULOSE | POLYETHER-BASED | METHYLISOBUTYL- | 3 | 10 | ±2 | ±3 |
| | FILM | POLYURETHANE RESIN\textcircled{5} | KETONE | | | | |
| EXAMPLE 40 | TRIACETYLCELLULOSE | POLYESTER-BASED | METHYLISOBUTYL- | 3 | 10 | ±2 | ±3 |
| | FILM | POLYURETHANE RESIN\textcircled{5} | KETONE | | | | |
| EXAMPLE 41 | TRIACETYLCELLULOSE | POLYESTER-BASED | METHYLISOBUTYL- | 3 | 10 | ±2 | ±3 |
| | FILM | POLYURETHANE RESIN\textcircled{6} | KETONE | | | | |
| EXAMPLE 42 | TRIACETYLCELLULOSE | POLYESTER-BASED | METHYLISOBUTYL- | 3 | 10 | ±2 | ±3 |
| | FILM | POLYURETHANE RESIN\textcircled{7} | KETONE | | | | |
| COMPARATIVE | TRIACETYLCELLULOSE | NIL | CYCLOHEXANONE | 0 | 0 | ±5 | ±10 |
| EXAMPLE 1 | FILM | | | | | | |
| COMPARATIVE | NORBORNENE-BASED | NIL | CYCLOHEXANONE | 0 | 0 | ±5 | ±10 |
| EXAMPLE 2 | FILM | | | | | | |
| COMPARATIVE | TRIACETYLCELLULOSE | WATER-DISPERSIBLE | CYCLOHEXANONE | 3 | 0 | ±4 | ±7 |
| EXAMPLE 3 | FILM | POLYMERIC POLYESTER | | | | | |
| | | \textcircled{1} | | | | | |
| COMPARATIVE | TRIACETYLCELLULOSE | WATER-DISPERSIBLE | CYCLOHEXANONE | 3 | 0 | ±4 | ±7 |
| EXAMPLE 4 | FILM | POLYMERIC POLYESTER | | | | | |
| | | \textcircled{2} | | | | | |
| COMPARATIVE | TRIACETYLCELLULOSE | POLYISOCYANATE | CYCLOHEXANONE | 3 | 0 | ±4 | ±7 |
| EXAMPLE 5 | FILM | | | | | | |
| COMPARATIVE | TRIACETYLCELLULOSE | ISOCYANATE | CYCLOHEXANONE | 3 | 0 | ±4 | ±7 |
| EXAMPLE 6 | FILM | | | | | | |
| COMPARATIVE | TRIACETYLCELLULOSE | AROMATIC POLYESTER | CYCLOHEXANONE | 3 | 0 | ±4 | ±7 |
| EXAMPLE 7 | FILM | | | | | | |
| COMPARATIVE | TRIACETYLCELLULOSE | POLYURETHANE RESIN\textcircled{1} | CYCLOHEXANONE | 3 | 10 | ±5 | ±10 |
| EXAMPLE 8 | FILM | | | | | | |
| COMPARATIVE | TRIACETYLCELLULOSE | NIL | METHYLISOBUTYL- | 0 | 0 | ±5 | ±10 |
| EXAMPLE 9 | FILM | | KETONE | | | | |
| COMPARATIVE | NORBORNENE-BASED | NIL | METHYLISOBUTYL- | 0 | 0 | ±5 | ±10 |
| EXAMPLE 10 | FILM | | KETONE | | | | |
| COMPARATIVE | TRIACETYLCELLULOSE | WATER-DISPERSIBLE | METHYLISOBUTYL- | 3 | 0 | ±4 | ±7 |
| EXAMPLE 11 | FILM | POLYMERIC POLYESTER | KETONE | | | | |
| | | \textcircled{1} | | | | | |
| COMPARATIVE | TRIACETYLCELLULOSE | WATER-DISPERSIBLE | METHYLISOBUTYL- | 3 | 0 | ±4 | ±7 |
| EXAMPLE 12 | FILM | POLYMERIC POLYESTER | KETONE | | | | |
| | | \textcircled{2} | | | | | |
| COMPARATIVE | TRIACETYLCELLULOSE | POLYISOCYANATE | METHYLISOBUTYL- | 3 | 0 | ±4 | ±7 |
| EXAMPLE 13 | FILM | | KETONE | | | | |
| COMPARATIVE | TRIACETYLCELLULOSE | ISOCYANATE | METHYLISOBUTYL- | 3 | 0 | ±4 | ±7 |
| EXAMPLE 14 | FILM | | KETONE | | | | |
| COMPARATIVE | TRIACETYLCELLULOSE | AROMATIC POLYESTER | METHYLISOBUTYL- | 3 | 0 | ±4 | ±7 |
| EXAMPLE 15 | FILM | | KETONE | | | | |
| COMPARATIVE | TRIACETYLCELLULOSE | POLYURETHANE RESIN\textcircled{1} | METHYLISOBUTYL- | 3 | 10 | ±5 | ±10 |
| EXAMPLE 16 | FILM | | KETONE | | | | |

Polyurethane Resin\textcircled{1}: Trade name Bondtighter HUX320, manufactured by Asahi Electrochemicals K.K.
Polyurethane Resin\textcircled{2}: Trade name Bondtighter HUX522, manufactured by Asahi Electrochemicals K.K.
Polyurethane Resin\textcircled{3}: Trade name Bondtighter HUX523, manufactured by Asahi Electrochemicals K.K.
Polyester-Based Polyurethane Resin\textcircled{1}: Trade name VYRON UR-1400, manufactured by Toyobo Co., Ltd.
Polyester-Based Polyurethane Resin\textcircled{2}: Trade name Bondtighter HUX232, manufactured by Asahi Electrochemicals K.K.
Polyester-Based Polyurethane Resin\textcircled{3}: Trade name SUPERFLEX E2000, manufactured by Dai-Ichi Kogyo Seiyaku CO., LTD.
Polyester-Based Polyurethane Resin\textcircled{4}: Trade name BONDIC 1250, manufactured by Dainippon Ink And Chemicals, Inc.
Polyester-Based Polyurethane Resin\textcircled{5}: Trade name HYDRAN HW-980, manufactured by Dainippon Ink And Chemicals, Inc.
Polyester-Based Polyurethane Resin\textcircled{6}: Trade name HYDRAN APX-101H, manufactured by Dainippon Ink And Chemicals, Inc.
Polyester-Based Polyurethane Resin\textcircled{7}: Trade name SPENSOL L512, manufactured by Dainippon Ink And Chemicals, Inc.
Polyether-Based Polyurethane Resin\textcircled{1}: Trade name SUPERFLEX 130, manufactured by Dai-Ichi Kogyo Seiyaku CO., LTD.
Polyether-Based Polyurethane Resin\textcircled{2}: Trade name SUPERFLEX 600, manufactured by Dai-Ichi Kogyo Seiyaku CO., LTD.
Polyether-Based Polyurethane Resin\textcircled{3}: Trade name BONDIC 1310 NSA, manufactured by Dainippon Ink And Chemicals, Inc.
Polyether-Based Polyurethane Resin\textcircled{4}: Trade name BONDIC 1320 NS, manufactured by Dainippon Ink And Chemicals, Inc.
Polyether-Based Polyurethane Resin\textcircled{5}: Trade name BONDIC 1510, manufactured by Dainippon Ink And Chemicals, Inc.
Polycarbonate-Based Polyurethane Resin\textcircled{1}: Trade name SUPERFLEX 410, manufactured by Dai-Ichi Kogyo Seiyaku CO., LTD.
Polycarbonate-Based Polyurethane Resin\textcircled{2}: Trade name SUPERFLEX 420, manufactured by Dai-Ichi Kogyo Seiyaku CO., LTD.
Polycarbonate-Based Polyurethane Resin\textcircled{3}: Trade name SUPERFLEX 460, manufactured by Dai-Ichi Kogyo Seiyaku CO., LTD.
Water-Dispersible Polymeric Polyester\textcircled{1}: Trade name VYLONAL MD-1400, manufactured by Toyobo Co., Ltd.
Water-Dispersible Polymeric Polyester\textcircled{2}: Trade name VYLONAL MD-1100, manufactured by Toyobo Co., Ltd.
Polyisocyanate: Trade name AQUANATE 100, manufactured by Nippon Polyurethane Industry Co., Ltd.
Isocyanate:Trade name DURANATE TPA-100, manufactured by Asahi Kasei Corporation
Aromatic Polyester: Trade name FINETEX ES2000, manufactured by Dainippon Ink And Chemicals, Inc.

As apparent from TABLE 1, an optical film having an adhesive layer of an urethane-based resin has a better adhesive power as compared with an optical film having no adhesive layer.

As is also apparent from the comparison of Examples 1 and 22 with Comparative Examples 1, 9, 3-8 and 11-16, the comparison of Examples 3 and 24 with Comparative Examples 2 and 10, it has been found that the adhesive layer of an urethane-based resin produces a better adhesive power, and also greatly reduces the variation in retardation since the stretching is made while the adhesive layer is held between the birefringent layer and the transparent polymer film layer. Also, as is apparent from the comparison of Examples 1 and 22 with Examples 5 and 26, it has been found that an optical film stretched with only the transparent polymer film pulled has smaller variation in retardation.

### Examples 43-48

A perfect transparent optical film having a birefringent layer was obtained in the same manner as Example 1 except that cyclopentanone, benzene, toluene, xylene, methoxybenzene and ethyl acetate are respectively used in place of cyclohexanone as a solvent for dissolving polyimide.

### Test Example 2

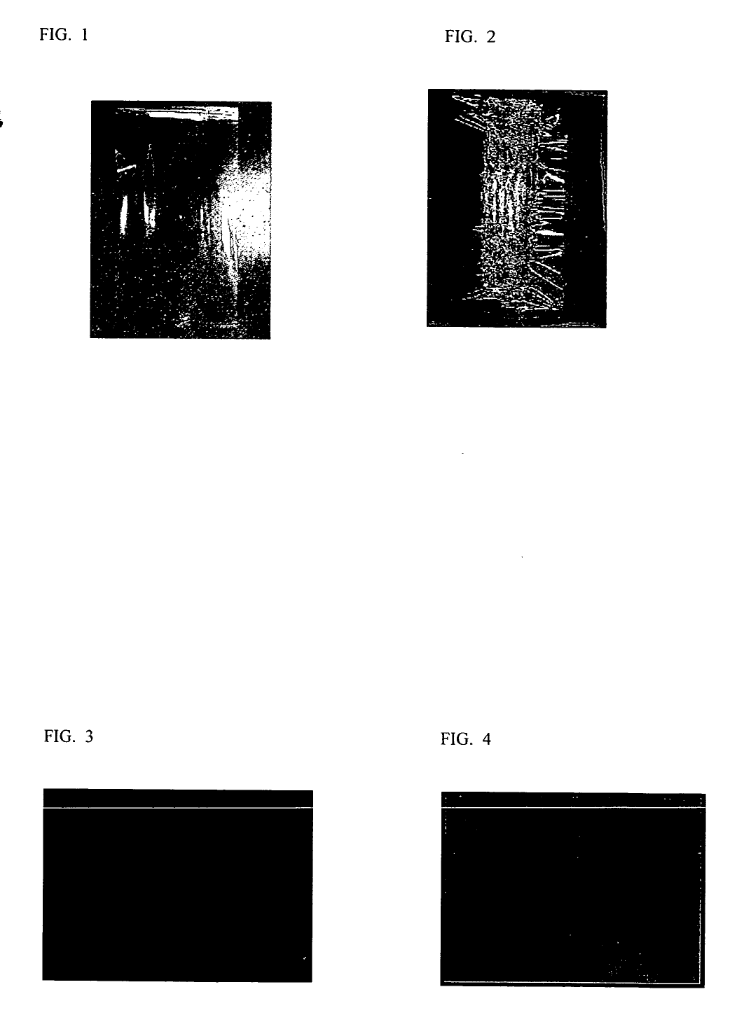

An appearance of the optical film of each of Examples 1-48 was evaluated based on visual observation. The symbol ◯ indicates that a film is flat and smooth with no wrinkles, surface undulations or the like observed. The symbol Δ indicates that wrinkles, surface undulations or the like are slightly observed. The symbol x indicates that wrinkles, surface undulations or the like are clearly observed. The results are shown in TABLE 2. Appearances of the optical films of Examples 2 and 43, respectively using methylisobutylketone and cyclopentanone were taken photographs. The results are shown in FIGS. 1 and 2.

TABLE 2

| | SOLVENT OF A SOLUTION | EVALUATION |
|---|---|---|
| | FOR A BIREFRINGENT | OF |
| | LAYER | APPEARANCES |
| EXAMPLES 1-21 | CYCLOHEXANONE | Δ |
| EXAMPLES 22-42 | METHYLISOBUTYLKETONE | ∘ |
| EXAMPLE 43 | CYCLOPENTANONE | Δ |
| EXAMPLE 44 | BENZENE | x |
| EXAMPLE 45 | TOLUENE | x |
| EXAMPLE 46 | XYLENE | x |
| EXAMPLE 47 | METHOXYBENZENE | x |
| EXAMPLE 48 | ETHYL ACETATE | x |

As is apparent from TABLE 2, and FIGS. 1 and 2, solvents other than methylisobutylketone eat into the surface of a triacetylcellulose film as a transparent polymer film, while sufficiently dissolve polyimide as a non-liquid crystal polymer. As a result, it has been found that wrinkles, surfaces undulations and the like occur in the optical films using these solvents.

### Examples 49 and 50

Optical films were obtained in the same manner as Examples 1 and 21 except that a polyethylene terephthalate film (approx. 75 μm) was used in place of a triacetylcellulose film (approx. 77 μm). Both optical films had Δn(a) (i.e., Δn of a polyimide layer) of 0.045, and Δn(b) (i.e., Δn of a polyethylene terephthalate film) of 0.08.

### Test Example 3

The optical films of Examples 1, 22, 49 and 50 each were respectively used as an optical film to be laminated on a backlight side of a liquid crystal cell of an LCD device, and the presence or absence of rainbow unevenness was observed when the LCD device was in black display mode. When the optical films of Examples 1 and 22 were used, rainbow unevenness was not observed. On the other hand, when the optical film of Examples 49 and 50 were used, rainbow unevenness was clearly observed. The results of Examples 22 and 50 were taken photographs, and the result when the optical film of Example 22 was used is shown in FIG. 3 and the result when the optical film of Example 50 was used is shown in FIG. 4.

As is apparent from the results of Test Example 3 and photographs of FIGS. 3 and 4, it has been found that the optical films of Examples 1 and 22 which satisfy the requirement of Δn(a)>Δn(b)×10 can satisfactory reduce rainbow unevenness in black display mode of an image display device.

This specification is by no means intended to restrict the present invention to the preferred embodiments set forth therein. Various modifications to the optical film, the polarizing plate, the liquid crystal cell, the liquid crystal display device, the image display device and the method of manufacturing an optical film, as described herein, may be made by those skilled in the art without departing from the spirit and scope of the present invention as defined in the appended claims.

1. An optical film comprising a transparent polymer film layer, an adhesive layer formed by coating a polyurethane-based resin solution on said transparent polymer film layer, and a birefringent layer formed by coating a non-liquid crystal polymer on said adhesive layer, these layers together forming a laminated film that is subjected to a stretching treatment.

2. The optical film according to claim 1, wherein said stretching treatment is achieved by applying a stretching force only onto said transparent polymer film.

3. The optical film according to claim 1, wherein said birefringent layer is formed by coating said non-liquid crystal polymer dissolved or dispersed in a solvent on said adhesive layer, and said solvent contains methylisobutylketone.

4. The optical film according to claim 1, wherein said birefringent layer satisfies the relational expression (1): nx≧ny>nz, in which nx, ny and nz respectively represent refractive indices in an X axis, a Y axis and a Z axis, of said birefringent layer; the X axis is an axis that gives a maximum in-plane refractive index; the Y axis is an in-plane axis perpendicular to the X axis; and the Z axis represents a thicknesswise direction perpendicular to the X axis and the Y axis

5. The optical film according to claim 1, wherein said adhesive layer has a thickness of 100 rm-10 μm.

6. The optical film according to claim 1, wherein said non-liquid crystal polymer is at least one selected from the group consisting of polyamide, polyimide, polyester, polyetherketone, polyamideimide and polyesterimide.

7. The optical film according to claim 1, wherein said transparent polymer film layer is made of any one of a triacetylcellulose film, a film made of a thermoplastic resin having an imide group, a phenyl group or a nitrile group in a side chain and a norbornene-based resin film.

8. The optical film according to claim 1, wherein the birefringence Δn(a) of the birefringent layer and the birefringence Δn(b) of said transparent polymer film layer satisfy the relative expression (2): Δn(a)>Δn(b))×10.

9. A polarizing plate comprising the optical film of claim 1 and a polarizer.

10. A liquid crystal cell comprising the optical film of claim 1.

11. A liquid crystal display device comprising the liquid crystal cell of claim 10.

12. An image display device comprising the optical film of claim 1.

13. A method of manufacturing an optical film comprising forming an adhesive layer by coating a polyurethane-based resin solution on a transparent polymer film layer and forming a birefringent layer by coating a non-liquid crystal polymer on the adhesive layer so as to prepare a laminated film, and subjecting said laminated film to a stretching treatment.

14. A liquid crystal cell comprising the polarizing plate of claim 9.

15. An image display device comprising the polarizing plate of claim 9.
